(19) United States
(12) Patent Application Publication
(10) Pub. No.: US 2022/0148397 A1
(43) Pub. Date: May 12, 2022

(54) APPARATUS, SYSTEM, AND METHOD FOR SECURITY COUNTERMEASURE SYSTEM

(71) Applicant: SENTRY BRITE LLC, Edina, MN (US)

(72) Inventor: Matthew SCHOEMAN, Edina, MN (US)

(73) Assignee: SENTRY BRITE LLC, Edina, MN (US)

(21) Appl. No.: 17/310,882

(22) PCT Filed: Feb. 27, 2020
(86) PCT No.: PCT/US2020/020065

§ 371 Date: Aug. 27, 2021

Related U.S. Application Data
(60) Provisional application No. 62/811,970, filed on Feb. 28, 2019.

(51) Int. Cl. G08B 13/196

(52) U.S. Cl. CPC G08B 13/19656

(57) ABSTRACT

This disclosure describes devices, systems, and methods related to security. An exemplary system includes a central computer, an object database including object data identifying a plurality of banned objects; a network interface configured to communicate with a control center; and a plurality of devices coupled to the central computer. A first device of the plurality of devices includes a camera, a network interface, and one or more non-lethal countermeasures. The central computer is configured to receive image data and compare the image data to the object data of the object database to identify a banned object of the banned objects. The central computer is configured to send a threat message to the control center and receive a control command from the control center. The central computer is configured to activate at least one of the non-lethal countermeasures based on the control command.

### CROSS-REFERENCE TO RELATED APPLICATIONS

This application is a national phase under 35 U.S.C. § 371 of International Application No. PCT/US2020/020065, filed Feb. 27, 2020, which claims the benefit of priority to U.S. Provisional Patent Application Ser. No. 62/811,970, filed Feb. 28, 2019, the entire contents of each of which are hereby incorporated by reference in their entirety.

### TECHNICAL FIELD

Aspects of the present disclosure relate generally to a security system, such as a security system for a school, and more specifically, but not by way of limitation, to a security system including countermeasures.

### BACKGROUND

Active shooter events are unfortunately very difficult to thwart or stop. Attempts to counter these events largely focus on reducing law enforcement response times and identifying warning indications. However, a majority of active shooter events are very short, leaving little time for law enforcement or bystanders to respond. Federal data on the duration of such events indicate that two thirds of all such events have a duration of 5 minutes or less and about half of the events end prior to the arrival of law enforcement. Federal Bureau of Investigation, “A Study of Active Shooter Incidents in the United States Between 2000 and 2013,” “A Study of Active Shooter Incidents in the United States from 2000-2017.” With conventional security systems, there is not a reliable method to prevent an active shooter or reduce casualties prior to the arrival of law enforcement. Thus, conventional methods and strategies emphasize reducing response times and often dictate that a first responding unit (e.g., a patrol unit) enter the area without backup.

Furthermore, even after response teams or law enforcement arrive, injury and death from confrontation are very high and occur in about half of all such events. Federal Bureau of Investigation, “A Study of Active Shooter Incidents in the United States Between 2000 and 2013”, “Active Shooter Incidents in the United States in 2014 and 2105,” and “Active Shooter Incidents in the United States in 2016 and 2017.” An additional challenge upon arrival is identifying the perpetrator from other individuals, some of which may be armed and acting lawfully in self-defense or the defense of others. Moreover, neutralizing the perpetrator of an active shooter event while preventing or reducing civilian injury in a densely populated foreign environment under time constraints is a unique challenge. Because of the importance of quick response times in preventing additional harm, response teams and law enforcement often have little to no knowledge of the environment. Usually, response teams and law enforcement have less knowledge about the area than the perpetrator who is often associated or familiar with the environment.

Additionally, attempts to develop early warning systems that attempt to predict events by using big data, machine learning, artificial intelligence, and the like have lots of false positives and cannot accurately predict active shooter events. One particular problem with such attempts is that the data used by these systems is often inaccurate or stale.

Other systems are capable of detecting an active threat, for example through object based detection or facial identification. However, such systems do not provide an effective means to prevent or reduce harm from the detected threat. Thus, most conventional systems rely on notifying authorities quickly after an event or threat has been identified, most often shortly after the event has occurred. Therefore, conventional security systems and methods for responding to active shooter events have been largely ineffective in preventing or reducing harm because the conventional systems cannot predict active shooter events long enough before they happen for responders to arrive and cannot reduce harm during an active shooter event.

### SUMMARY

This disclosure describes devices, systems, and methods related to identifying, reducing, and/or neutralizing security threats. An exemplary security system may include two sub-systems, a control center and an on-site security system. In some implementations, the on-site security system may include or correspond to a distributed system including a central computer and plurality of sentry devices including surveillance equipment and countermeasures. The central computer may receive surveillance data, such as images, and identify threats based on the surveillance data. For example, the central computer may receive video data and identify banned objects, such as weapons, based on comparing the video data to object databases. Once a match is identified by the on-site system or confirmed by a user, the central computer of the on-site system alerts the control center and authorizes the control center to access the sentry devices of the on-site system via a secure network connection. The control center can access surveillance data and activate countermeasures to reduce and/or neutralize a security threat. Accordingly, response times can be drastically reduced and security threats can be identified and possibly neutralized before the threat does harm. To illustrate, a firearm may be detected on a person when the person brandishes the firearm (e.g., removes the firearm from a concealed area or bag) and before the person uses the firearm.

Also, the countermeasures can be activated before the person uses the firearm. Accordingly, as compared to conventional response procedures where a responding unit is off-site and has to travel to the site after a gunshot is detected and reported, the devices, systems, and methods disclosed herein are able to identify possible threats automatically and provide access to on-site countermeasure to respond to threats before use. Thus, the devices, systems, and methods described herein can reduce harm and save lives.

Additionally, up to date (e.g., near real-time) and accurate information can be provided to responding units, security personnel, on-site associates, off-site associates, or a combination thereof. For example, law enforcement and security personnel may be provided with video feeds, and/or snapshot pictures from sentry devices. As another example, on-site associates, such as students, employees, tenants, etc., can receive updates or instructions from the system to avoid the threat or reduce harm. In addition, relatives or persons associated with on-site associates can receive updates or instructions from the system. To illustrate, identification of the threat, the location of the threat, and instructions for avoiding the threat may be communicated to such people in near real-time. Accordingly, such device, systems, and methods can be used to more quickly and more accurately to inform people about threats and how to avoid them, as compared to conventional security systems, alarms, and pre-programmed mass text alerts. Thus, the devices, systems, and methods described herein can reduce harm and save lives.

In some implementations, pre-declared hostile people or threats may be identified by facial recognition. Exemplary people or threats include criminals at large, expelled students, terminated employees, etc. Additionally, or alternatively, the discharge of a firearm and/or its location may also be detected by gunshot sensors, such as audio or infrared (IR) based sensors.

In some implementations, once event or alert criteria is met, an alarm and/or notifications are initiated and sent over an end-to-end encrypted, remote Virtual Private Network (VPN) or another type of secure connection to Law Enforcement and Law Enforcement is connected to on-site video cameras and non-lethal countermeasures (or less-lethal countermeasures). As used herein, a secure connection includes an electronic communications method that is encrypted, such as the Hypertext Transfer Protocol Secure (HTTPS). As an illustrative example, near-live video feeds may be automatically pushed to Law Enforcement and mobile devices of on-site security personnel via a secure connection. In a particular implementation, after a multi-factor security authentication, a Law Enforcement agency or unit may choose to remotely activate the non-lethal countermeasures against the active shooter. The VPN connection is existing or previously established in some implementations to time eliminate lost time negotiating the link during an event. Alternatively, the VPN connection may be opened or established responsive to an event in other implementations to reduce access to portions of the on-site system. As another illustrative example, alarms, notifications, video data, and/or other system messages may be initiated and sent over a different type of secure connection, such as a HTTPS secure protocol extension, Secure Sockets Layer (SSL), Transport Layer Security (TLS), Secure Shell (SSH), Public Key Infrastructure (PKI), public-key cryptography, or end-to-end encryption (E2EE).

Additionally, image data and text alert criteria can be sent to Law Enforcement units and designated contacts. In some implementations, mobile devices of Law Enforcement units begin pushing Global Positioning System (GPS) or WiFi Positioning System (WPS) locational updates and site arrival notices to other Law Enforcement units or mobile devices. In some implementations, building security configurations can be used to automatically lock doors towards the active shooter or threat, open exits or escape paths for users, or a combination thereof.

Thus, the devices, systems, and methods described herein enable an event or threat to be identified before harm occurs, such as in an active shooter event before the first shots are fired. The devices, systems, and methods described herein provide security personal and/or Law Enforcement the capability to remotely stop or slow an active shooter rapidly, such as within less than 30 seconds of the detection of an incident. Additionally, the devices, systems, and methods described herein can prevent access to protected areas by a threat and provides immediate and robust situational awareness of an event or threat to Law Enforcement and on-site personnel in order to prevent or limit police and civilian harm. For example, such a system enables law enforcement and civilians to identify the perpetrator of an active shooter event and also distinguish them from other individuals. Accordingly, the devices, systems, and methods described herein enable improved response times and remote countermeasure control, thereby reducing harm and saving lives.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically. Additionally, two items that are “coupled” may be unitary with each other. To illustrate, components may be coupled by virtue of physical proximity, being integral to a single structure, or being formed from the same piece of material. Coupling may also include mechanical, thermal, electrical, communicational (e.g., wired or wireless), or chemical coupling (such as a chemical bond) in some contexts.

The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. As used herein, the term “approximately” may be substituted with “within 10 percent of” what is specified. Additionally, the term “substantially” may be substituted with “within [a percentage] of” what is specified, where the percentage includes 0.1, 1, or 5 percent; or may be understood to mean with a design, manufacture, or measurement tolerance. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or.

The terms “comprise” (and any form of comprise, such as “comprises” and “comprising”), “have” (and any form of have, such as “has” and “having”), and “include” (and any form of include, such as “includes” and “including”). As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any aspect of any of the systems, methods, and article of manufacture can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, it will be understood that the term “wherein” may be used interchangeably with “where.”

Further, a device or system that is configured in a certain way is configured in at least that way, but it can also be configured in other ways than those specifically described. The feature or features of one embodiment may be applied to other embodiments, even though not described or illustrated, unless expressly prohibited by this disclosure or the nature of the embodiments.

Some details associated with the aspects of the present disclosure are described above, and others are described below. Other implementations, advantages, and features of the present disclosure will become apparent after review of the entire application, including the following sections: Brief Description of the Drawings, Detailed Description, and the Claims.

### BRIEF DESCRIPTION OF THE DRAWINGS

A further understanding of the nature and advantages of the present disclosure may be realized by reference to the following drawings. The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a block diagram of an example of a security system;

FIG. 2 is a block diagram of another example of a security system;

FIG. 3 is a block diagram of an example of a device of a security system;

FIG. 4 is a block diagram of another example of a device of a security system;

FIG. 5 is a ladder diagram of an example of installation of a security system;

FIG. 6 is a ladder diagram of an example of use/monitoring of a security system;

FIG. 7 is a ladder diagram of an example of activation of a security system;

FIG. 8 is a ladder diagram of an example of control of an on-site security system;

FIG. 9A is a side view of an example of a device of a security system in a first state;

FIG. 9B is a side view of an example of the device of FIG. 9A in a second state;

FIG. 10 is a block diagram of an example of devices of a security system;

FIG. 11 is a block diagram of another example of devices of a security system;

FIG. 12A is a side view of an example of a device of a security system in a first state;

FIG. 12B is a side view of an example of the device of FIG. 12A in a second state;

FIG. 13 is a high level block diagram of an example of information flow in a security system; and

FIG. 14 is a block diagram of another example of a security system.

### DETAILED DESCRIPTION

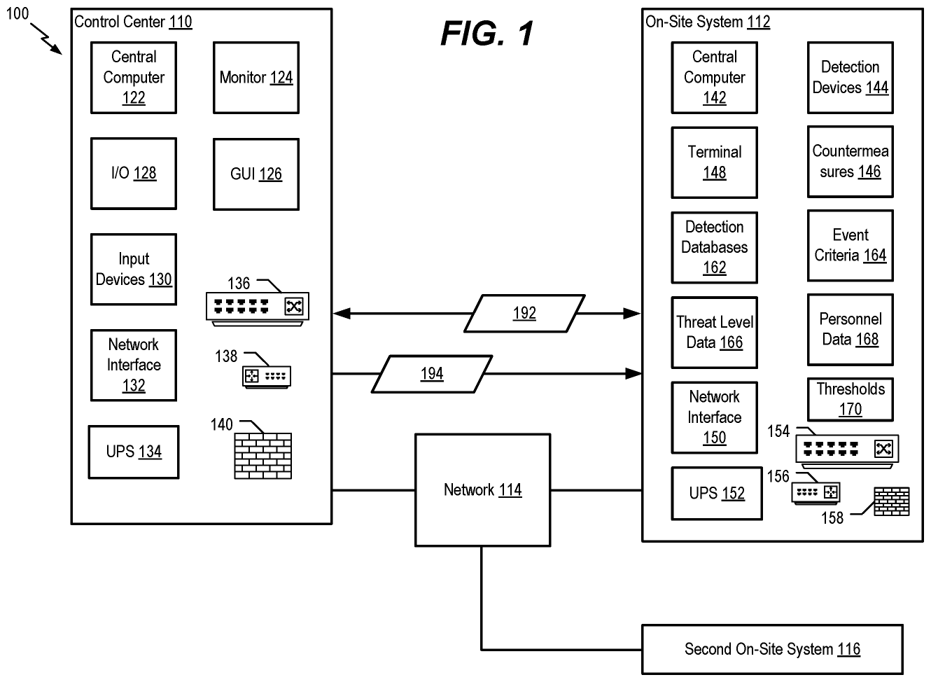

FIG. 1 illustrates a block diagram of an example of a security system 100 (referred to herein as “system 100”) for automatic threat detection and controlled response. System 100 includes a control center 110 (e.g., command center) and an on-site system 112 (e.g., on-site security system). System 100 is configured to identify events or threats and to implement responses to the events or threats. For example, control center 110 may receive notifications 192 from the on-site system 112 and send commands 194 to on-site system 112 to neutralize an event, such as an active shooter event. One such exemplary use of security system 100 is as a security system for schools, universities, or other public or private buildings. Exemplary events include active shooter identification and response, banned object identification and response, and banned person identification and response.

As illustrated in FIG. 1, the control center 110 includes a central computer 122, a monitor 124, a graphical user interface (GUI) 126, input/output (I/O) interfaces 128, input devices 130, a network interface 132, an uninterruptable power supply (UPS) 134, a switch 136, a router 138, and a firewall 140.

The central computer 122 includes a processor and a memory coupled to the processor. The memory is configured to store instructions that when executed by the processor, cause the processor to perform the operations described herein. For example, the processor may perform operations as described with reference to FIGS. 1, 2, and 5-7. In some implementations, the central computer 122 includes a graphics processor, such as a dedicated graphics card or graphics processing unit (GPU).

Central computer 122 may include or correspond to an electronic device, such as a communications device, a mobile phone, a cellular phone, a satellite phone, a computer, a server, a tablet, a portable computer, a display device, a media player, or a desktop computer. Additionally, or alternatively, the central computer 122 may include any other device that includes a processor or that stores or retrieves data or computer instructions, or a combination thereof.

The GUI 126 is configured to display information from on-site system 112, such as notifications, and is configured to enable a user to generate commands for on-site system 112, such as countermeasure control commands. The GUI 126 may display image data, video data, map data, location data, threat data, instruction data, countermeasure data, etc.

The I/O interface 128 includes or corresponds to an interface and bus for receiving and sending data to local devices and other local computers. For example, the I/O interface 128 may include or correspond to a Universal Serial Bus (USB) interface.

The one or more input devices 130 may include a mouse, a keyboard, a joystick, a microphone, a display device, other input devices, or a combination thereof, and may be coupled to the central computer 122 via the I/O interface 128. In some implementations, the processor generates and sends commands responsive to receiving one or more user inputs from the one or more input devices 130 via the I/O interface 128.

The network interface 132 includes or corresponds to a networking interface and bus for receiving and sending data to other computers over a network, such as network 114. For example, network interface 132 may include a transmitter, a receiver, or a combination thereof (e.g., a transceiver), and may enable wired communication, wireless communication, or a combination thereof.

UPS 134 is configured to automatically provide power to a device or system, such as when the input power source or main power fails. The UPS 134 may be configured to provide power until an auxiliary or emergency power system or standby generator can be activated to provide power to the device or system. The UPS 134 may include batteries, supercapacitors, flywheels, etc.

Control center 110 includes networking equipment for communicating with on-site systems 112, 116. As illustrated in FIG. 1, the control center 110 includes the switch 136, the router 138, and the firewall 140. Such network components may be separate from central computer 122 and enable central computer 122 to communicate with other systems and devices of system 100. The firewall 140 may include or correspond to software or functionality of the switch 136, the router 138, or both. For example, the router 138 may block ports, may restrict some information from being sent, received, or both, from a particular port or ports, may block certain data or content, or a combination thereof, based on software, e.g., firewall 140.

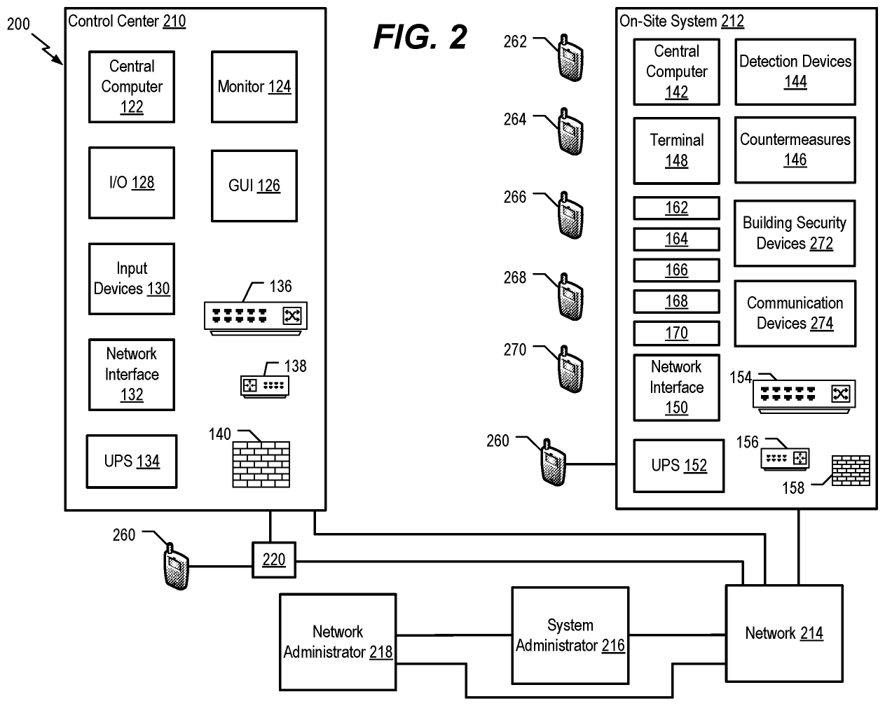

The control center 110 is configured to receive data and messages from on-site system 112, such as a notification 192 (e.g., a notification message). Additionally, the control center 110 is configured to send commands to on-site system 112, such as a command 194 (e.g., a command message), responsive to the notification 192. In some implementations, the control center 110 is further configured to send additional messages and data to on-site system 112, and optionally, to users associated with on-site system 112, as described further with reference to FIG. 2.

In other implementations, functions of the control center 110 may be distributed. For example, administrative tasks may be controlled by a first entity and response control may be controlled by a second different entity, as described further with reference to FIG. 2.

In some implementations, control center 110 is configured to receive other messages and information from on-site system 112. For example, control center 110 may receive a text alert of an event or threat, a snapshot of alert or event criteria, an image of the alert or event, a live stream of video, a map of the facility, a location of the alert of event on the map of the facility, a location (GPS or WPS derived) of responding units, and a status of security systems.

The text alert of an event or threat may include or correspond to an automated message generated by on-site system 112, a text message from a user of on-site system 112, or a silent alarm message from on-site system 112. In some implementations, the map of the facility is stored locally and identified based on the message or retrieved from an external database, as opposed to being received in the message from the on-site system 112. In a particular implementation, the map includes or corresponds to a gridded reference graphic. The map and locations of objects thereon may be updated dynamically as information from the on-site system 112, and optionally mobile device associated therewith, is pushed to control center 110 and/or on-site system 112. The status message of security systems may include information on components of the on-site system 112 and building security system, such as a status of door locks, fire alarms, countermeasures, etc. The status information may indicate, locked, safe, operable, inoperable, out of munition, etc.

In some implementations, control center 110 is configured to send messages and commands responsive to received messages from the on-site system 112. Control center 110 may be configured to send messages to on-site system 112 and to other devices associated with users of on-site system 112. Exemplary messages include text messages, escalation event messages, alter message, public address (PA) system messages, building command messages (e.g., a door lock command), countermeasure command messages, etc. An escalation event message may be pushed to law enforcement field units. The escalation event message may be received from the on-site system 112 (e.g., input by the on-site administrator) or generated by the control center 110 automatically based on the notification 192.

In some implementations, control center 110 is configured to forward messages from users in the field, grant access or control to users in the field or both. For example, control center 110 may receive a message or action from a mobile device and route the message to the on-site system 112. As an illustrative, non-limiting example a mobile device may request a video feed or activate a countermeasure by generating and sending a command message to control center 110 which routes the message to on-site system 112 via a secure network (e.g., a virtual private network and/or a multi-factor authentication secured connection).

As illustrated in FIG. 1, the on-site system 112 includes a central computer 142, one or more threat detection devices 144, one or more countermeasures 146, a terminal 148 (e.g., a computer or workstation), a network interface 150, UPS 152, a switch 154, a router 156, and a firewall 158. In some implementations, the on-site system 112 is operable with crisis management applications, such as CrisisGO. The central computer 142 may include or correspond to the central computer 122.

The one or more threat detection devices 144 may include or correspond to surveillance devices or sensors. For example, the one or more threat detection devices 144 may include cameras, microphones, etc. The cameras may include high-resolution cameras, IR cameras, night vision cameras, 360 degree cameras, etc. The microphone or audio capture device may include an array of microphones, one or more directional microphones, etc. The one or more countermeasures 146 may include or correspond to non-lethal countermeasures which are configured to identify, deter, slow, and/or incapacitate a person identified as a threat.

The terminal 148 may include or correspond to a computer of on-site system 112, such as a desktop computer, a laptop computer, a tablet, a mobile device (e.g., smartphone), a workstation, or a server. The terminal 148 may include or correspond to the central computer 142 in some implementations. For example, the terminal 148 may house the central computer 142 and the central computer 142 includes or corresponds to a processor and memory (e.g., controller) of the terminal 148. Alternatively, the terminal 148 may by separate and distinct from the central computer 142 in other implementations. For example, each of the central computer 142 and the terminal 148 correspond to separate computing devices which are coupled to each other via a local area network of on-site system 112.

The on-site system 112 further includes detection databases 162, event criteria 164, threat level data 166, personnel data 168, and thresholds 170. The detection databases 162, the event criteria 164, the threat level data 166, the personnel data 168, and/or the thresholds 170 may be stored at the central computer 142 (e.g., a local memory thereof) or stored/hosted on a local server.

The detection databases 162 include libraries used in/for object detection, such as firearm object libraries, firearm discharge libraries, knife object libraries, weapon object libraries. In a particular implementation, detection databases 162 include firearm discharge infrared signature libraries, firearm discharge muzzle flash signature libraries, or both. Such libraries may enable the use of IR images to identify gunshots.

In some implementations, the detection databases 162 include libraries used in/for facial recognition detection, such as public databases and/or private databases. Examples of public databases include databases or data related to Violent Criminals At-Large, All-Points Bulletins (APB), Sexual Predators, Wanted Persons—National Crime Information Center (NCIC), National Sex Offender Public Website (NSOPW)—Department of Justice (DOJ). Examples of private databases include databases or data related to the on-site entity and personnel thereof, such as restraining order data, terminated employee data, expelled students data, suspended students data, at-risk individuals data, etc. Additionally, or alternatively, the detection databases 162 include libraries used in/for audio detection, such as firearm discharge audio signature libraries, firearm discharge percussion signature libraries, or both.

The event criteria 164 includes data defining events and/or threats and log data for previously occurred events and/or threats. The log data may include previously identified threats, confirmed threats, or both. Threat level data 166 includes libraries or databases on threat levels of identified events and/or threats and accompanying procedures, such as door locking procedure, automatic notification procedures, alarm procedures, countermeasure procedures etc.

The personnel data 168 includes libraries or databases of registered users and information regarding the registered users. For example, personnel data 168 includes what level of access a user has, what device(s) and or relatives are associated with the user, etc. The thresholds 170 includes data indicating thresholds for matching and identifying an object, a threat, or an event. The thresholds 170 include data indicating thresholds for actions and user permissions associated with a particular level of access. The thresholds 170 may indicate what actions can be taken by the on-site system 112 for an identified threat level.

On-site system 112 may include one or more categories of people or users. For example, on-site system 112 may include one or more of an administrator, a security person, on-site staff, an on-site associate (e.g., secured person, such as student, employee, tenant, etc.), or an off-site associate (e.g., parents family). Each category of people or users may have different levels of access and use of on-site system 112, such as stored in personnel data 168. Each person or user may be associated with a device, such as mobile device, and the device may be configured to send and receive messages via system 100. The device data may include authorization keys or multi-factor authentication data and may be stored with the personnel data 168 or with networking data, such as at the router or switch.

In some implementations, on-site system 112 includes an administrator, such as an on-site administrator. The administrator may be configured to receive a text alert of an event, a snapshot of alert criteria of the event, a picture of the event, a live stream of video of the event, map information of the facility, a location of the event (updated dynamically), and/or facility information. Facility information may include information and details on facility background, such as security protocol used, security training completion, alert plan of action. The map information may include a gridded reference graphic (map with grid overlay). The administrator may be configured to receive such information on a mobile device associated with administrator and/or on a device (e.g., the terminal 148) of on-site system 112 onto which the administrator is logged on.

The administrator may be configured to activate alarms, send messages, initiate an event, escalate the event, and enable remote control or access by third parties, such as control center 110 and mobile devices associated with control center 110. For example, the administrator may be configured to activate silent alarms, audible alarms, or a combination thereof. The administrator may be configured to send messages that includes alerts/notifications, texts messages, public address messages, and escalation messages. An escalation message or escalating an event may also enable or activate remote control or monitoring by Law Enforcement.

Additionally, or alternatively, on-site system 112 includes security personnel, such as on-site security personnel. Security personnel may have similar privileges as compared to an on-site administrator and may be configured to receive and send the same or similar types of messages described above. In addition, security personnel may be able to access a tip reporting tool via terminal 148 or a mobile device. Additionally, or alternatively, the security personnel (e.g., an on-campus law enforcement office) may be able to activate and control countermeasures in particular implementations, under particular conditions, or both.

In some implementations, privileges and messages may be shared or unique between on-site administrator and security personnel. Shared privileges are privileges that both the administrator and security personnel (or persons designated with such a title) can use, such as initiate an event. Unique privileges are privileges that only one or the other of the administrator and security personnel (or persons designated with such a title) can perform, such as send/receive a particular type of message. As an example of unique privileges, in a particular implementation the administrator is the only class of users who can initiate an event and security personnel is the only class of user who can activate countermeasures.

In some implementations, the on-site administrator has the sole authority and privileges to add or edit a private database (e.g., Opt-in Facial Recognition data). The private database may have corresponding thresholds level and rules for alerts, notifications, and/or actions that are the same as or different from the public database. In the event of a facial recognition match, the system 100 will perform one or more actions that were preset by the on-site administrator.

In other implementations, the on-site system 112 further includes building security devices (e.g., door locks), communication devices (e.g., a PA system or a speaker), or both. In such implementations, the control center 110 is configured to control the on-site system 112 building security devices, communication devices, or both, via commands 194, as described further with reference to FIG. 2.

The second on-site system 116 is installed at and corresponds to another portion of the facility, or alternatively, is installed at and corresponds to another facility at a location separate from a location of facility of the on-site system 112. The second on-site system 116 may include components similar to on-site system 112. As an illustrative example, some facilities may be large, spread out, contain multiple entities, etc., such that a particular facility may include multiple on-site systems.

The network 114 may include or correspond to a public internet network managed by an internet service provider (ISP). Sub-systems (e.g., 110, 112, 116) of system 100 are configured to communicate with each other over the network 114. Additionally, sub-systems (e.g., 110, 112, 116) of system 100 may be configured to communicate (e.g., such as send certain type of messages and information) with each other over a cellular network, as described further with reference to FIG. 2.

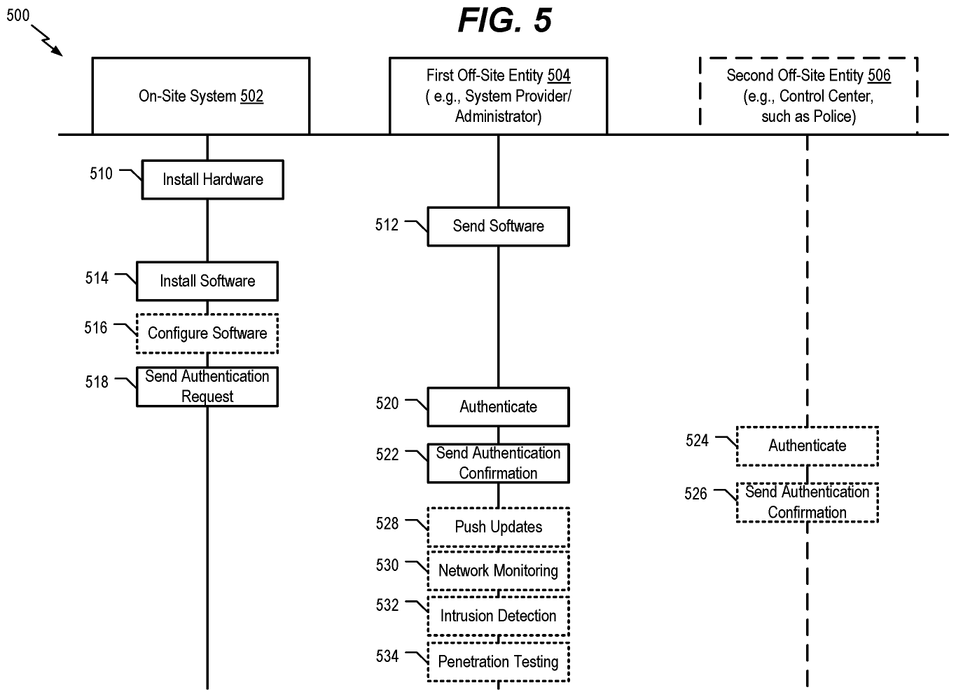

Operations of system 100 are described further with reference to FIG. 2 and in detail with reference to FIGS. 5-8. System 100 is capable of identifying an event or threat by using object detection, facial recognition, and/or audio recognition. System 100 is capable of employing non-lethal countermeasures over a secure connection. For example countermeasures may be controlled over a virtual private network or another secure connection, which is end-to-end encrypted and accessed by multi-factor authentication.

System 100 is further capable of automatically sending (e.g., pushing) information to particular entities to improve knowledge of people near the threat or automatically engaging building security devices. For example, a video snapshot and text alert criteria is sent to Law Enforcement units, and optionally, other designated contacts. As another example, near-live video feed may be automatically pushed to Law Enforcement and on-site security mobile devices. Additionally, mobile devices of Law Enforcement, optionally connected to a wireless network of on-site system 112, may begin pushing GPS or WPS locational updates and site arrival notices to other Law Enforcement mobile devices. As yet another example, doors locks can be activated to automatically lock doors towards the active shooter or threat to contain the active shooter or threat.

The system 100 can be configured to (e.g., customizable to) carry out different preset actions based on different events or threats, threat levels, or other criteria. With regards to messaging, as an illustrative example, if a firearm is detected by any sensor, then all groups may be notified, such as control center 210, mobile device 260, all on-site personnel, and off-site associates. However, if a knife is identified, less than all groups may be notified or only specific users in a particular group may be notified. For example, if a knife or other weapon is identified with or on student A, the parents of student A are messaged, and other off-site associates are not messaged. As another example, if a facial recognition match is identified to a known threat, students and off-site associates may not be notified or only students near the location of the known threat are messaged.

With regards to actions, as an illustrative example, if a firearm is detected by any sensor, then detection device 144 control access and countermeasure 146 control access are immediately provided to control center 210. However, if a knife or other weapon is identified or a known threat is detected then detection device 144 control access may be immediately provided to control center 210 and countermeasure 146 control access is provided to control center 210 responsive to escalation. The automated response settings may be set and/or managed by control center 210, on-site system administrator, an off-site system administrator (e.g. 216), or a combination thereof.

Thus, system 100 describes a security system for identifying events and responding to the events. System 100 enables advanced warning and notice by using image/video based object detection, as compared to conventional audio based gunshot detection. Accordingly, system 100 enables reduced response time as compared to conventional audio based gunshot detection, which has been identified by the federal government as the best way to prevent and reduce harm. For example, by starting the response clock or timer before use of the firearm or weapon, law enforcement can arrive at the location earlier than if notice was provided after or responsive to discharge of the firearm.

Additionally, system 100 enables reduction or prevention of harm by incorporation of on-site non-lethal countermeasure. Use of such countermeasures can be controlled by trained and/or legally allowed entities and only activated upon detection of a threat, and optionally confirmation of the threat. The distributed nature of the system and control over a secure connection reduces or prevents premature or unintended use of countermeasure and allows a threat to be identified, deterred, slowed, or incapacitated prior to use of a weapon or firearm.

Furthermore, system 100 enables distribution of near real-time information to people on-site and responders such that responding units are more effective and cause less collateral damage. Accordingly, system 100 solves many of the shortcomings of conventional systems and methods for responding to events, especially active shooter events, and can reduce harm and save lives.

Referring to FIG. 2, a block diagram of another illustrative security system 200 (“referred to as system 200”) is illustrated. System 200 includes a control center 210, an on-site system 212, a network 214, a system administrator 216, and a network administrator 218. Control center 210 may include or correspond to control center 110, and on-site system 212 may include or correspond to on-site system 112 of FIG. 1. Network 214 may include or correspond to network 114. System 200 is configured to communicate via network 214, and optionally cellular network 220. For example, system 200 may be configured to communicate message and data to mobile devices, such as mobile devices 260-270, associated with one or more entities (e.g., 210, 212, 216, 218) of system 200.

As illustrated in FIG. 2, on-site system 212 further includes one or more building security devices 272 and one or more communication devices 274, relative to on-site system 112. The one or more building security devices 272 may include or correspond to door locks, alarms, shutters, fire sprinklers, etc., of the facility where on-site system 212 is located. The one or more building security devices 272 may enable control center 210 to control activation and deactivation of the one or more building security devices 272. Such control may enable law enforcement to enable people to escape, confine a threat, or a combination thereof.

The one or more communication devices 274 may include or correspond to speakers (e.g., loudspeakers) of a public address system of the facility where on-site system 212 is located. Additionally, or alternatively, the one or more communication devices 274 may include or correspond to speakers of one or more surveillance or sentry devices of on-site system 212, such as a speaker is incorporated with a detection device of the one or more detection devices 144 or a countermeasure of the one or more countermeasures 146. The communication device 274 may enable communication (e.g., commands, instructions, etc.) with people that are on-site 212 by control center 210.

The system administrator 216 is configured to provide software and updates to components of system 200, such as control center 210, on-site system 212, mobile devices 260-268, etc. Exemplary updates include database or library updates, machine learning updates, training set updates. In some implementations, system administrator 216 is configured to monitor on-site system status and/or adjust on-site system settings, such as threshold threat levels, authorization levels, etc.

The network administrator 218 is configured to provide network and device monitoring and to provide network updates to components of system 200, such as control center 210, on-site system 212, mobile devices 260-268, etc. Exemplary services provide by the network administrator 218 include network monitoring, intrusion detection, penetration testing, etc. Although the network administrator 218 is illustrated as separate from the system administrator 216, the system and network administrators may be one entity in other implementations.

In some implementations, one or more components of system 200 can send messages and data via a cellular network 220, such as via a cellular service provider. As illustrated in FIG. 2, control center 210 can send or push data and messages to devices associated with control center 210, such as mobile device 260, via the cellular network 220. Exemplary messages and data include data about an incident occurring at a site or building where on-site system 212 is located. The messages and data may include threat identification data, map data, etc., as described further herein. In some implementations, the mobile device 260 is associated with law enforcement, such as an on-duty or patrol officer. In a particular implementation, the mobile device 260 is associated with on-site security personnel for on-site system 212. In some implementations, the mobile device 260 includes an application to enable mobile device 260 to access the local wireless network of on-site system 212 when the mobile device 260 is within range of the local wireless network . Additionally, or alternatively, the mobile device 260 may connect to on-site system 212 via the cellular network 220 and the virtual private network. In other implementations, other wireless networks are used, such as short wave radios.

When the mobile device 260 is associated with a law enforcement officer, the mobile device 260 may be configured to receive a text alert of an event, a snapshot of alert criteria of the event, a picture of the event, a live stream of video of the event, map information of the facility, a location of the event (updated dynamically), and facility information.

When the mobile device 260 is associated with a law enforcement officer, the mobile device 260 may be configured to activate alarms (e.g., silent alarms, audible alarms, etc.), send messages, initiate an event, escalate the event, and remotely control countermeasures of on-site system 112. The mobile device 260 may be configured to send messages that includes alerts/notifications, texts messages, public address messages, escalation messages, acknowledge alert messages (e.g., responding to alert or assuming control of on-site countermeasures), location message (e.g., GPS or WPS location data), or a combination thereof.

In some implementations, the system 200 (e.g., the on-site system 212) sends or pushes messages to multiple users or people associated with on-site system 212. For example, the multiple users may be separated into multiple classes of users, such as administrators, staff, students, employees, off-site associates (e.g., parents). The on-site system 212 may be configured to push different messages and data to different users based on an access level of the user or class or users, a type of threat, a threat level, an identity of the threat, or a combination thereof. As illustrative examples, the on-site system 212 may push image data, map data, threat data, route data, instructions, alerts, notifications, etc. to devices associated with the users. As illustrated in the example of FIG. 2, mobile devices 262-268 receive messages and data from on-site system 212 via the network 214, cellular network 220, or a combination thereof. In a particular example, mobile device 262 is associated with an on-site administrator, mobile device 264 is associated with on-site security, mobile device 266 is associated with on-site staff, mobile device 268 is associated with on-site associates (e.g., students, employees, tenants, etc.), and mobile device 270 is associated with off-site associates (e.g., parents, relatives, etc., of on-site people).

In some implementations, mobile devices (e.g., 262-266) associated with on-site staff or a category of on-site staff (e.g., trusted staff, managers, teachers, etc.) are configured to send and receive message. For example, the mobile devices may receive a text alert or email of an event, instructions, map information, a security protocol checklist, evacuation information, route information. The mobile devices may also receive text message updates and information from the control center 210, the on-site system 212 or both. Additionally, the mobile devices may be configured to send text messages to control center 210, on-site system 212, or both. For example, an application on the mobile devices may be configured to send an alarm activation message configured to activate a silent alarm, an audible alarm, or both. Additionally, or alternatively, the application on the mobile device may include a tip reporting tool to enable the staff to provide information about a threat to system 200.

In some implementations, mobile devices (e.g., 268) associated with on-site (e.g., students, employees, tenants, etc.) are configured to send and receive message. For example, the mobile devices may receive a text alert or email of an event, instructions, a security protocol checklist, evacuation information, route information. The mobile device may also receive text message updates and information from the control center 210, the on-site system 212 or both. Additionally, the mobile devices may be configured to send text messages to control center 210, on-site system 212, or both. For example, an application on the mobile device may include a tip reporting tool to enable off-site associated to provide information about a threat to system 100.

In some implementations, mobile devices (e.g., 270) associated with off-site associates of on-site personnel are configured to send and receive message. For example, the mobile devices may receive a text alert or email of an event or threat for re-unification instructions. The mobile device may also receive text message updates and information from the control center 210, the on-site system 212 or both. Additionally, the mobile devices may be configured to send text messages to control center 210, on-site system 212, or both. For example, an application on the mobile device may include a tip reporting tool to enable off-site associated to provide information about a threat to system 100. Operation of system 200 is described further with reference to FIGS. 5-8

Thus, system 200 describes a security system for identifying events and responding to the events. System 200 includes benefits and advantages over conventional systems similar to the benefits and advantages that system 100 has over conventional systems, as described with reference to FIG. 1

Furthermore, system 200 enables distribution of near real-time information to mobile devices of people on-site and responders such that responding units are more effective, less at risk of harm, and cause less collateral damage. Additionally, system 200 enables providing near real time information based on a current location of the people on-site such that people on-site can better avoid the threat. Accordingly, system 200 solves many of the shortcomings of conventional systems and methods for responding to events, especially active shooter events, and can reduce harm and save lives.

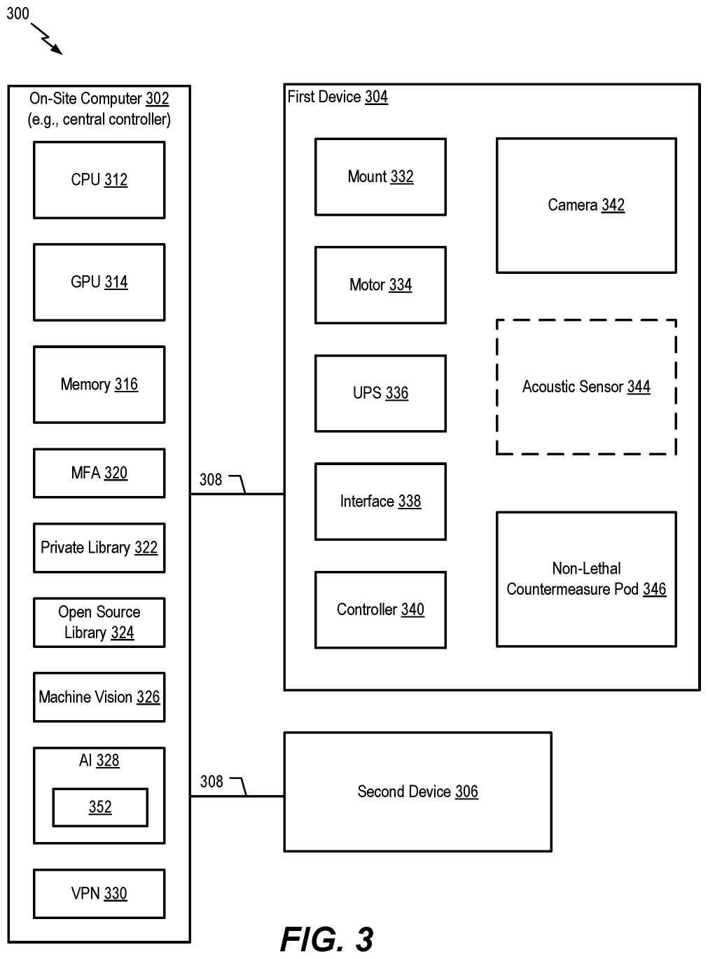

Referring to FIG. 3, a block diagram of an example of an on-site system 300 is illustrated. System 300 includes an on-site computer 302, a first device 304, and a second device 306. System 300 may include or correspond to an on-site security system, such as on-site system 112 or on-site system 212.

As illustrated in FIG. 3, data link wires 308 couple the components of system 300 together. The data link wires 308 may be wired individually or maybe combined, such as routed in a local junction box before relay to on-site computer 302. In other implementations, one or more components of the system 300 are wirelessly coupled together. In such implementations, the components may be securely connected of a wireless network similar to as described with reference to FIGS. 1 and 2.

On-site computer 302 may include or correspond to a central computer or central controller (e.g., 142) that is configured to control devices of system 300, such as first and second devices 304, 306. On-site computer 302 includes a processor 312 (e.g., central processing unit (CPU)), a graphics processor 314 (e.g., graphics processing unit (GPU)), and a memory 316. The memory 316 is configured to store instructions and data, such as one or more of multi-factor authentication, which may include end-to-end encryption program data 320, private library data 322, open-source (e.g., public) library data 324, machine vision data 326, artificial intelligence data 328, or virtual private network (VPN) data 330. Memory 316, such as a non-transitory computer-readable storage medium, may include volatile memory devices (e.g., random access memory (RAM) devices), nonvolatile memory devices (e.g., read-only memory (ROM) devices, solid-state drive devices, programmable read-only memory, and flash memory), or both.

In some implementations, processor may include or correspond to a microcontroller/microprocessor, a central processing unit (CPU), a field-programmable gate array (FPGA) device, an application-specific integrated circuits (ASIC), another hardware device, a firmware device, or any combination thereof. Processor may be configured to execute instructions to initiate or perform one or more operations described with reference to FIG. 1, FIG. 2, and/or one more operations of the ladder diagrams of FIGS. 5-8.

MFA data 320 includes a Multi-Factor Authentication program and authentication data. In some implementations, the Multi-Factor Authentication program is hardware based, and relies on “what you have” as one of the factors of authentication. In a particular example, the Multi-Factor Authentication program receives data from a hardware device, such as a one-time password. The hardware device (e.g., a physical two factor authentication device) may include or correspond to a physical token. Additionally, the Multi-Factor Authentication program relies on at least one of “what you know” (e.g., password, pin, etc.) or “what you are” (e.g., fingerprint, audio signature, retinal scan, etc.). Alternatively, two-step authentication can be used, and the on-site computer 302 includes two-step authentication data. To illustrate, two-step authentication involves using one of the three authentication factors, such as a trusted device or password, to prompt the system 300 to send a one-time dynamic password to the device or account associated with the user. Upon entry of the one-time dynamic password, the system 300 grants the user access.

Private library data 322 may include private libraries developed by a system administrator, such as system administrator 216 of FIG. 2, by an on-site system administrator, an entity associated with the system 300, or a combination thereof. The private library data 322 may include audio libraries, object/image libraries, threat libraries, or a combination thereof. For example, audio libraries may include audio libraries of authorized users, banned users, etc. The object/image libraries may include images and or video of authorized users, banned users, authorized objects, banned objects, etc. The threat libraries may include images, audio, and/or other identifying data on known identified threats, threats identified by a system administrator, an on-site system administrator, an entity associated with the on-site system, or a combination thereof.

Open source library data 324 may include publicly available, open source libraries, such as open source audio libraries, open source object/image libraries, open source threat libraries, or a combination thereof. As an illustrative non-limiting example, one exemplary open source sound library is Google AudioSet. The open source object/image libraries may include images of weapons, weapon discharges (e.g., IR images of weapon discharges), and banned items. Illustrative examples of open source object/image libraries include ImageNet and Google Open Images. The open source threat libraries may include images, audio, and/or other identifying data on known criminals, sex offenders, wanted lists, etc.

Machine vision data 326 includes a machine vision program configured to recognize/classify faces and objects, thus performing facial recognition and object detection. For example, the machine vision program is configured to identify faces of people and/or objects based on processing received images/video through (e.g., using) an artificial intelligence (AI) model 352 that has been trained on private library data 322, open source library data 324, or both. To illustrate, the machine vision program is configured to process received images through an AI model 352, trained on library data to identify weapons, i.e., a firearm in a person's hand or an outline of a firearm in a person's coat or backpack. Accordingly, identification of the threat occurs before harm or damage, and alerts and/or notifications can be activated prior to use of the weapon. Additionally, such advanced alerts and/or notifications may enable the threat to be neutralized prior to harm or damage, such as by non-lethal countermeasures of system 300. One exemplary machine vision program includes OpenCV. In some implementations, the machine vision program is configured to engage in parallel computing, such as Nvidia CUDA, to increase processing bandwidth and decrease identification time. For example, a single image may be compare to thousands of library images simultaneously. As another example, the on-site computer 302 may process video feed or images from both the first device 304 and the second device 306 simultaneously.

In some implementations, the machine vision program is configured to determine a gunshot or explosion based on IR image data. For example, a heat signature of a firearm or bomb may be captured by an IR camera and compared to library data to identify a gunshot or explosion. Thus, even if a firearm is not recognized prior to use by object recognition, the system 300 can identify a firearm after use.

Optionally, the memory 316 includes a sound recognition program and data when acoustic sensors are incorporated into one or more of the devices. The sound recognition program is configured to identify sounds in received audio data. For example, the sound recognition program is configured to identify gunshots or bomb explosions based on comparing the identified sounds to private library data 322, open source library data 324, or both. The sound recognition program may provide an additional backup to image based detection and may be able to detect gunshots or bomb explosions that are not in-line of sight of any of the devices (304, 306) of system 300.

Artificial Intelligence (AI) data 328 includes or corresponds to a machine learning program or an AI program configured to enhance machine vision, sound recognition, or both. As an illustrative example, the AI program uses a convolutional neural network (CNN) to enhance and speed up machine vision processing. Additionally, or alternatively, the AI program is configured to receive results of the machine vision, sound recognition, or both, and analyze the results before alerting a user and presenting the results to the user to limit false positives. In a particular implementation, the AI program is configured to activate alerts, send notifications or both, based on the results and threat level thresholds independent of user input. The AI data 328 may use the log data of previously identified threats and/or confirmed threats to filter newly identified threats. In some implementations, the AI data 328 may include one or more AI models 352 which are used to process data. The AI models may be trained and updated based on library data and/or training sets.

The VPN data 330 includes a Virtual Private Network program and settings. In some implementations, the VPN includes or corresponds to a PIA (private internet access) VPN. The VPN may include or correspond to a PPTP type VPN, a L2TP/IPsec type VPN, a SOCKS5 type VPN, an OpenVPN type VPN, or a combination thereof. The virtual private network may be established or authorized based on a multi-factor authentication process and using the MFA data 320.

Communications between the on-site computer 302 and the devices (304, 306) may be secure. For example, an End-to-End Encryption program or protocol, such as Hypertext Transfer Protocol Secure (HTTPS) may be used to encrypt/decrypt data sent between components of system 300. As an illustrative, non-limiting example, a particular End-to-End Encryption programs includes public and private keys to encrypt and decrypt data.

The on-site computer 302 may be comprised of commercial off the shelf (COTS) equipment to reduce costs and increase interoperability and maintainability. For example, the CPU may include or correspond to one or more consumer grade CPUs and the GPU may include or correspond to one or more consumer grade GPUs. Accordingly, such a system may have reduced component costs as compared to conventional systems which often rely on specialty hardware.

The first device 304 includes a mount 332, a motor 334, a UPS 336, an interface 338, a controller 340, a camera 342, and a non-lethal countermeasure pod 346 (e.g., one or more countermeasures). Optionally, the first device 304 may include one or more acoustic sensors 344. The first device 304 may be configured to be ceiling mounted or wall mounted (e.g., side mounted) such that a portion of the device is hidden. For example, the non-lethal countermeasure pod 346 may be recessed or positioned behind a wall or ceiling. The mount 332 is configured to house the camera 342 and the non-lethal countermeasure pod 346. In some implementations, the mount 332 is or includes a motorized mount and the motor 334 is configured to move the entire mount, such as pan, tilt, and/or rotate. Additionally, or alternatively, the mount 332 is retractable and the motor 334 is configured to lower and/or raise the mount 332.

The UPS 336 is configured to provide power to first device 304 and may include or correspond to the UPS 134 of FIG. 1. Interface 338 may include a network interface and/or a device interface configured to be communicatively coupled to one or more other devices, such as on-site computer 302, second device 306, or both. For example, interface 338 may include a transmitter, a receiver, or a combination thereof (e.g., a transceiver), and may enable wired communication, wireless communication, or a combination thereof. In a particular implementation, the interface 338 is configured to communicate with the on-site computer 302 over a wired connection and may include or correspond to the network interface 132 of FIG. 1.

The controller 340 may include a processor and a memory, as described with reference to FIG. 1, and is configured to control operation of the first device 304 response to commands from on-site computer 302. As explained with reference to FIGS. 1 and 2, one or more of the commands may include or correspond to command messages (e.g., 192) from control center 110, 210. To illustrate, controller 340 receives a command message from on-site computer 302 and generates a control signal based on the command message. The controller 340 sends the control signal to a component of the first device 304 to cause activation of and/or control the component. For example, the non-lethal countermeasure pod 346 may be controlled by the controller 340 responsive to and based on the received control signals.

The camera 342 is configured to capture image data. In some implementations, the camera is configured to capture video data. The image or video data may include or correspond to Internet Protocol digital image/video data. In some implementations, the camera 342 is a high resolution camera, e.g., a 4K Ultra High Definition camera or greater. The camera 342 may have a wide angle lens or support 360 degree viewing. Alternatively, the camera 342, or mount 332, is configured to be adjusted and moved by motor 334, such that the camera 342 has pan, tilt, and rotation capabilities. In some implementations, the camera 342 has digital or optical zoom and/or autofocus capabilities.

The one or more acoustic sensors 344 are configured to capture audio data. In some implementations, the acoustic sensors 344 correspond to a plurality of microphones or microphone array. The acoustic sensors 344 may include near field microphones, far field microphones, beamforming microphones, etc. Accordingly, the audio data captured by the one or more acoustic sensors can be analyzed by on-site computer 302 to determine location. In a particular implementation, the one or more acoustic sensors correspond to an Acoustic Vector Sensor (AVS) and include a plurality of microphones, such as 4 or more microphones. Thus, location or origination of the source of the sound can be determined in a three dimensional space. Additionally, one or more other sensors may be included in the first device 306 in other implementations, such as fire sensors (e.g., smoke detectors), bomb or chemical sensors (e.g., spectrometers), etc.

The non-lethal countermeasure pod 346 includes one or more non-lethal devices configured to incapacitate, slow, and/or deter an identified threat. The non-lethal countermeasure pod 346 may include one or more non-lethal countermeasures, such as, but not limited to a laser, a pepper-spray projectile, a pepper spray dispersal device, a light emitting diode (LED) incapacitator, a capsule launcher, bean bag launcher, a kinetic launcher (rubber bullets), a Taser, sonic nausea device, or a combination thereof. In some implementations, countermeasures are deployed remotely only by authorized personal such as Law Enforcement.

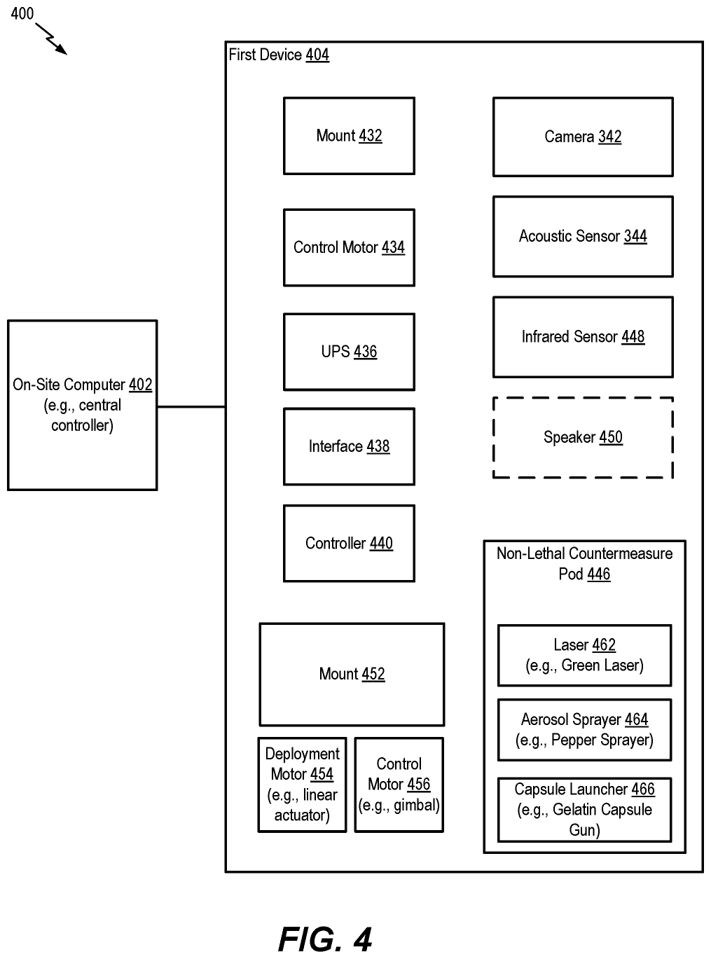

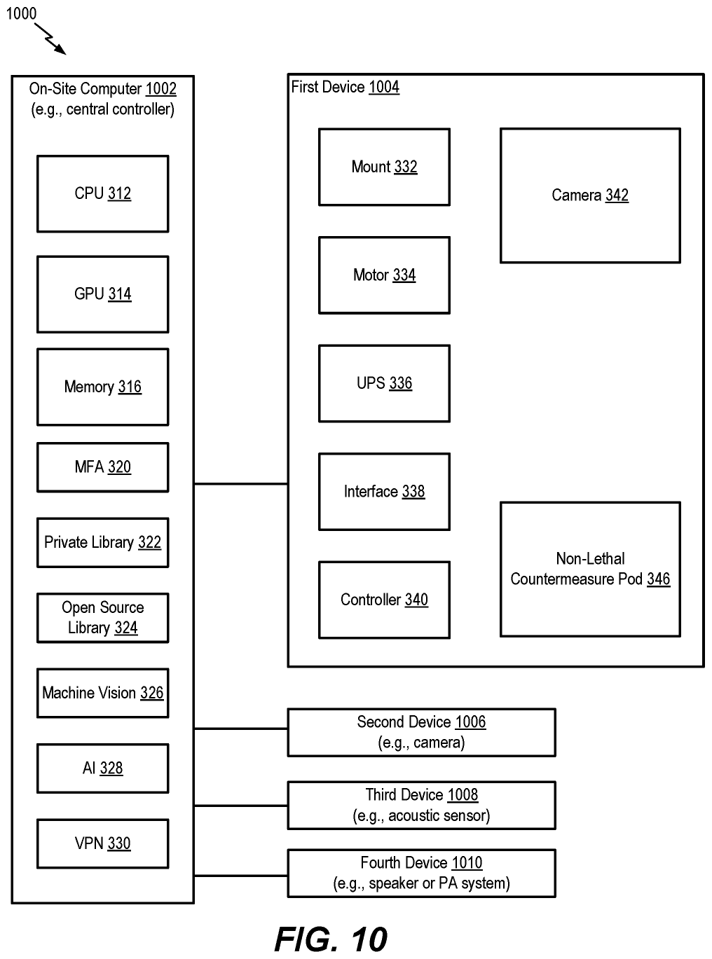

The second device 306 may include one or more of the components described with reference to the first device 304. In a particular implementation, the second device 306 includes the same components as the first device 304. In other implementations, the second device 306 includes different components as compared to the components of the first device 304. For example, in another implementation the second device 306 includes one of the components of the first device 304 of FIG. 3 in the alternative to the first device 304 including the component. Some exemplary configurations where the first device 306 and the second device 306 have different components are described further with reference to FIGS. 10, 11, 12A, and 12B. As illustrated in FIG. 3, the second device 306 is hardwired to the on-site computer 302. In other implementations, the second device 306 is coupled to the on-site computer 302 via the first device 304. The on-site system 300 may include other devices, such as described with reference to FIGS. 4, 10, 11, 12A, and 12B. Operation of the on-site system 300 is described further with reference to FIGS. 4-8.

Referring to FIG. 4, a block diagram of another example of an on-site system 400 is illustrated. System 400 includes an on-site computer 402, a first device 404, and one or more other devices (e.g., 306), as described further with reference to FIGS. 10, 11, 12A, and 12B. System 400 may include or correspond to an on-site security system, such as on-site system, 112, on-site system 212, or system 300. On-site computer 402 may include or correspond to central computer 142 or on-site computer 302; first device 404 may include or correspond to detection devices 144, countermeasure 146, first device 304, or a combination thereof.

The first device 404 includes a mount 432, a control motor 434, a UPS 436, a camera 342, an acoustic sensor 344, a non-lethal countermeasure pod 446, an infrared sensor 448, a mount 452, a deployment motor 454, and a control motor 456. Additionally, the first device 404 includes an interface and a controller, such as interface 338 and controller 340 of FIG. 3.

In FIG. 4, mount 432 is configured to house exposed components, such as detection devices (e.g., 342, 344, 448), and mount 452 is configured to house recessed components, such as non-lethal countermeasure pod 446. Control motors 434, 456 are configured to move and adjust their respective mounts 432, 452. In some implementations, one or more of control motors 434, 456 include or correspond to gimbals and enable rotation in multiple axes. Deployment motor 454 is configured to deploy mount 452 and expose the non-lethal countermeasure pod 446 from a recessed position. In some implementations, deployment motor 454 includes or corresponds to a linear rack or piston drive system. In other implementations, mount 452 is configured to be deployed based on gravity, such as by releasing pins, and a motor is used to retract mount 452.

As illustrated in FIG. 4, the non-lethal countermeasure pod 446 includes a laser 462, an aerosol sprayer 464, and a capsule launcher 466. The countermeasures 462-466 of the non-lethal countermeasure pod 446 are configured to be activated and controlled by remote control. To illustrate, the first device 404 receives commands from the central controller 402 and a controller (e.g., 440) of first device 404 generates control signals based on the control commands and which are configured to control countermeasures 462-466.

Laser 462 includes or corresponds to an eye safe laser or a dazzle laser, also referred to as a dazzler. In some implementations, the laser 462 emits visible light, e.g. a green laser of Laser Class 1, Class 1M, Class 2, or Class 2M. In other implementations, the laser 462 emits infrared light. The laser 462 may include an aiming system. In a particular implementation, the laser 462 includes its own aiming system and the laser 462 is adjustable relative to the non-lethal countermeasure pod 446, and optionally one or more of the other countermeasures 464, 466. The laser 462 may also be configured to be used as an aiming guide for one or more of the other countermeasures 464, 466.

Aerosol sprayer 464 is configured to disperse a chemical (e.g., dye and/or irritant) via a propellant to identify, deter, and/or incapacitate an identified threat which is within close range, such as within 20 feet. Aerosol sprayer 464 includes an applicator or nozzle and a stored chemical and propellant. In some implementations, the aerosol sprayer 464 includes or corresponds to an irritant spray canister. The irritant spray canister includes a pressurized irritant such as a capsaicinoid, for example, Pelargonic Acid Vanillylamide (PAVA), a nozzle, and an activation mechanism. Additionally, or alternatively, the aerosol sprayer 464 includes or corresponds to a paint or marking spray canister. The paint or marking spray canister includes a pressurized marking agent, such as a non-water soluble paint, dye, or permanent ink, a nozzle, and an activation mechanism.

Capsule launcher 466 is configured to launch a capsule to identify, deter, and/or incapacitate an identified threat. Capsule launcher 466 may be capable of identifying, deterring, slowing, and/or incapacitating an identified threat at long range, such as up to 200 feet. In some implementations, the capsule launcher 466 includes or corresponds to a gelatin capsule gun, such as a mechanically operated or electro-pneumatically operated capsule gun. In a particular implementation, the capsule launcher 466 (e.g., a pneumatic gelatin capsule gun) includes a barrel, a magazine (e.g., magazine assembly), a gas system, a propellant, and a frame.

As an illustrative, non-limiting example, the barrel is a 0.68 caliber barrel and is 6.25-inch-long metal barrel. The magazine (e.g., magazine assembly) may be operated by a coil spring or gravity feed, gravity assist, etc. The barrel is configured to launch capsule projectiles, such as gelatin Capsule Projectiles—containing an irritant, a marker, or both. Exemplary irritants include such irritants as a capsaicinoid, for example, Pelargonic Acid Vanillylamide (PAVA) in powder, liquid, or gel form. As an illustrative, example, the launch capsule projectiles may include or correspond to paintballs filled with an irritant. A skirt or an aerodynamic tail can be added to paintballs or other spherical projectiles to increase distance and accuracy.

Additionally, or alternatively, the capsules includes a brightly colored marking ink or dye in powder, liquid, or gel form. In a particular implementation, the capsule launcher includes multiple types of capsules, such as, irritant capsule and marking capsules. Additionally, or alternatively, the capsule launcher includes projectiles of different shape and sizes (e.g., shape variations) in order to improve accuracy and range.

The gas system may include a trigger mechanism, a bolt and valve assembly, and a propellant, such as compressed air or compressed carbon dioxide. The trigger mechanism may be mechanically operated, electronically actuated, or electro-pneumatically operated. As illustrative example, the trigger mechanism may include a switch, a computer control circuit, a solenoid valve, etc. In some implementations, the bolt and valve assembly includes a firing valve assembly, a regulator assembly and, an air valve assembly. Optionally, the bolt and valve assembly includes a puncture device or pin to pierce a closed propellant cylinder (e.g., a Carbon Dioxide (CO₂) cartridge).

The propellant may include or correspond to a tank or canister of compressed air or compressed Carbon Dioxide (CO₂). The propellant may be sealed and may be punctured in response to deployment of the countermeasure pod or activation of the capsule launcher. The frame may include metal and/or plastic construction.

Additionally, as illustrated in FIG. 4, the non-lethal countermeasure pod 446 includes a corresponding mount 452 and motors 454, 456. Deployment motor 454 is configured to deploy mount 452 and non-lethal countermeasure pod 446, and control motor 456 is configured to adjust mount 452, non-lethal countermeasure pod 446, components of non-lethal countermeasure pod 446, or a combination thereof.

Although the non-lethal countermeasure pod 446 includes three countermeasures in FIG. 4, in other implementations, the non-lethal countermeasure pod 446 includes fewer countermeasures, additional countermeasures, and/or different countermeasures, such as one or more of the countermeasures described with reference to non-lethal countermeasure pod 346 of FIG. 3.

In a particular implementation, the IR sensor 448 is configured to capture IR signatures and generate IR signature data. In another implementation, the IR sensor 448 (e.g., an IR camera) is configured to capture IR images and generate IR image data. The IR data is sent to the on-site computer 402 for processing and threat detection, such as by comparing to IR database data.

In some implementations, the first device 404 includes a speaker 450. The speaker 450 is configured to output audio received from the on-site computer 402. The audio may include or correspond to commands, instructions, etc. to people on-site. The audio may be generated on-site (e.g., at terminal 148), by a mobile device (e.g., 260-270), or by a control center (e.g., 110, 210), as described further herein. The on-site system 400 may include other devices, such as described with reference to FIGS. 3, 10, 11, 12A, and 12B. Operation of the on-site system 400 is described further with reference to FIGS. 5-8.

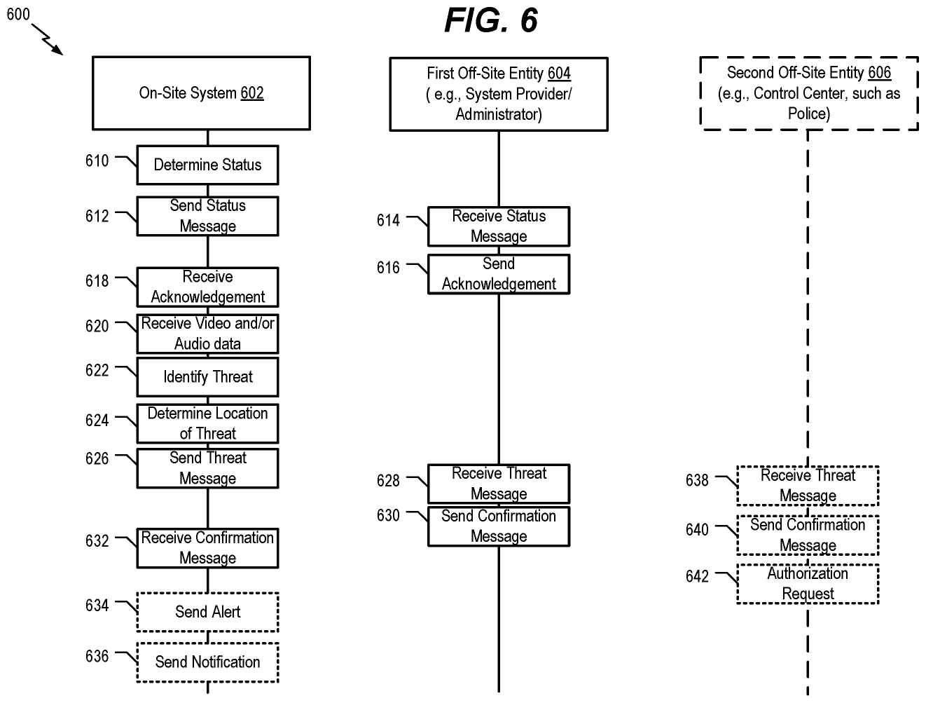

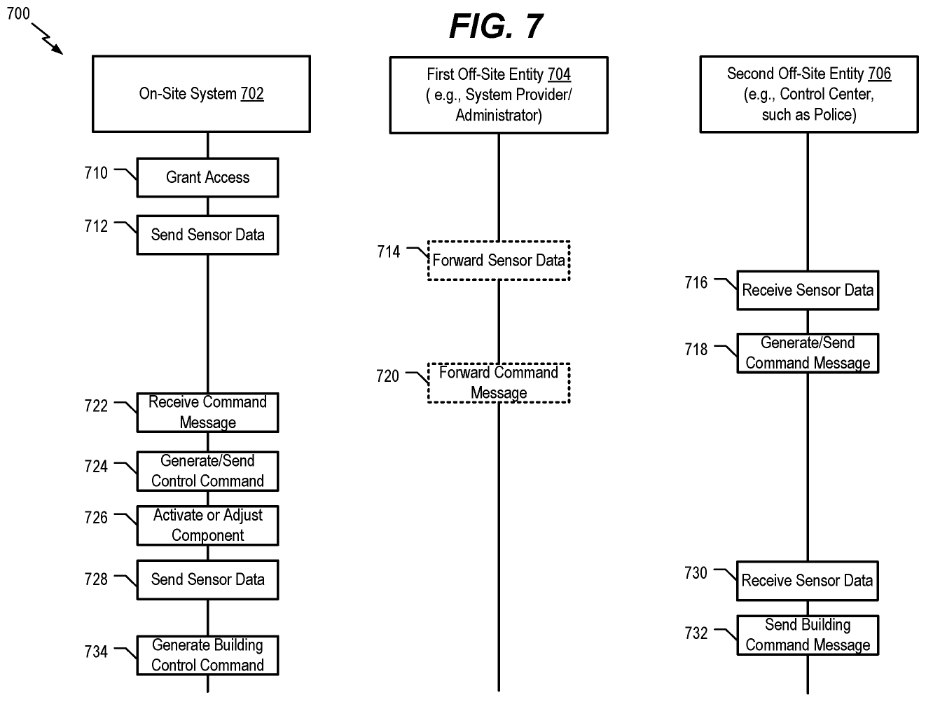

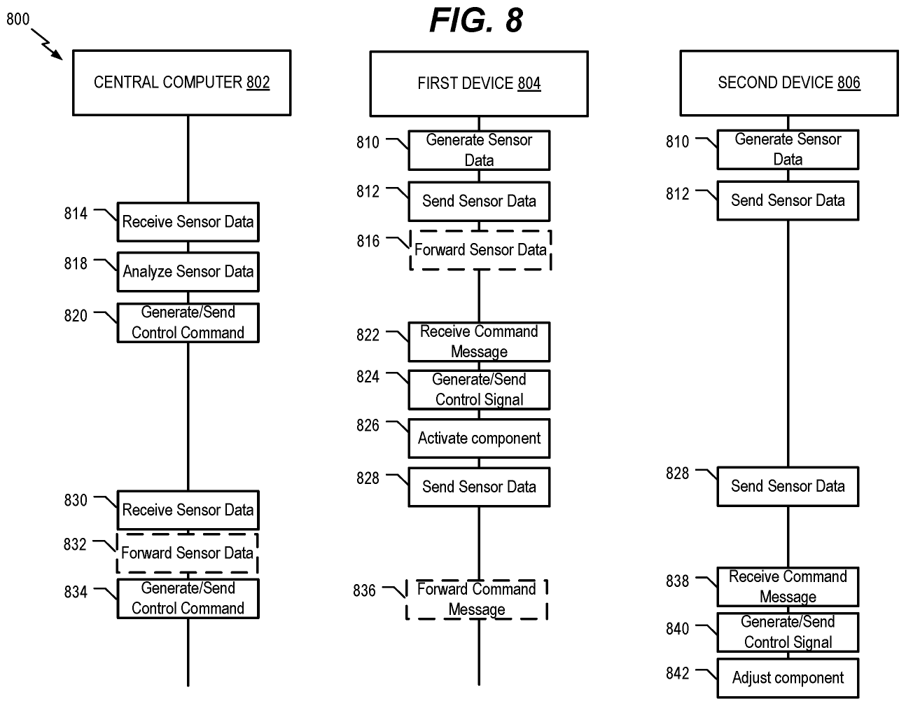

Referring to FIGS. 5-8, ladder diagrams of examples of operation of security systems are shown. Timing of actions of components of the security systems are illustrated in the ladder diagrams with time extending in the downward direction. FIG. 5 illustrates installation and setup of a security system, FIG. 6 illustrates monitoring of a security system, FIG. 7 illustrates activation and response of a security system, and FIG. 8 illustrates operation of an on-site security system of the security system.

Referring to FIG. 5, an example operation of system installation and setup is shown. As illustrated in FIG. 5, example system 500 includes an on-site system 502, a first off-site entity 504, and optionally, a second off-site entity 506. On-site system 502 may include or correspond to on-site system 112, on-site system 212, system 300, or system 400. The first and second off-site entities 504, 506 may include or correspond to a control center (e.g., 210), a system administrator (e.g., 216), a network administrator (e.g., 218), or a mobile device (e.g., 260-270). As illustrated in FIG. 5, the first off-site entity 504 includes or corresponds to a system administrator (e.g., 216), and the second off-site entity 506 includes or corresponds to a control center (e.g., 210) and/or a mobile device associated therewith (e.g., 260).

During operation, hardware of on-site system 502 is installed at a facility at 510, such as a school, factory, office, etc. For example, multiple surveillance and/or sentry devices are coupled to facility at various locations throughout a facility. The multiple surveillance and/or sentry devices are then coupled to (e.g., hardwired to) a central controller or computer, such as a computer or server. Software is then installed on the hardware of on-site system 502 at 514. As illustrated in the example of FIG. 5, software is received from the first off-site entity 504 at 512. In some implementations, software, such as databases or database data, is received from the second off-site entity 506. For example, criminal databases can be received from the second off-site entity 506, as described with reference to FIG. 1. Alternatively, the software is pre-loaded on the hardware of on-site system 502 prior to installation or is loaded from local storage by a system admin or staff of the facility.

In some implementations, the software installed at on-site system 502 is configured by a system admin or staff of the facility at 516. For example, threshold data may be entered or configured to set thresholds for event detection, event criteria data may be entered or configured to identify events and threat levels, etc. Alternatively, the software installed at on-site system 502 is configured remotely by an off-site entity, such as the first off-site entity 504.

After the software installed at on-site system 502 (and optionally configured), the on-site system 502 authenticates with an off-site entity, such as first off-site entity 504. For example, the on-site system 502 and the first off-site entity 504 establish a secure connection and authorization credentials. Additionally, or alternatively, the on-site system 502 and the second off-site entity 506 establish end-to-end encryption, a virtual private network, and/or authorization credentials. In a particular implementation, multiple levels of encryption may be used. For example, an end-to-end encryption program can be used with a VPN to have two layers of encryption. To illustrate, the end-to-end encryption program encrypts all traffic/message content, such as data of command messages, notifications, etc. The encrypted message content is then sent via the VPN link, which is also encrypted, such as by end-to-end encryption (e.g., second end-to-end encryption).

In a particular implementation, the on-site system 502 sends an authentication request at 518 and receives an authentications response or confirmation message. In the example illustrated in FIG. 5, the on-site system 502 sends an authentication request to the first off-site entity 504. The first off-site entity 504 performs an authentication process at 520 and sends an authentication confirmation at 522. Additionally, or alternatively, the on-site system 502 establishes multi-factor authentication data, public and private keys (e.g., Rivest-Shamir-Adleman (RSA) public and private keys), etc., for mobile devices of or associated with an off-site entity (e.g., the first off-site entity 504, the second off-site entity 506, or both). Additional authentication messages may be sent to establish multi-factor authentication data and other secure tokens or keys.

The on-site system 502 may optionally authenticate with the second off-site entity 506. For example, the on-site system 502 may send the authentication request or a second authentication request to the second off-site entity 506. As another example, the first off-site entity 504 forwards the authentication request to the second off-site entity 506. The second off-site entity 506 performs an authentication process at 524 and sends and authentication confirmation at 526.

In some implementations, an off-site entity sends (e.g., pushes) updates to on-site system 502. For example, the first off-site entity 504 may send (e.g., push) software updates at 528. As another example, second off-site entity 506 may send (e.g., push) database updates.

Additionally, or alternatively, an off-site entity monitors and/or tests on-site system 502 and mobile devices associated with on-site system 502 and mobile devices which are authorized to use or access on-site system 502. For example, the first off-site entity 504 may monitor network traffic of on-site system 502 and mobile devices associated with on-site system 502 at 530 and may monitor attempts to access of on-site system 502 remotely at 532, i.e., intrusion detection. As another example, the first off-site entity 504 may attempt to gain access to on-site system 502 in unauthorized or unintended ways or from unauthorized or unintended devices at 534, commonly referred to as penetration testing.

Referring to FIG. 6, an example operation of monitoring by the system is shown. As illustrated in FIG. 6, example system 600 includes an on-site system 602, a first off-site entity 604, and optionally, a second off-site entity 606. On-site system 602 may include or correspond to on-site system 112, on-site system 212, system 300, system 400, or system 502. The first and second off-site entities 604, 606 may include or correspond to a control center (e.g., 210), a system administrator (e.g., 216), a network administrator (e.g., 218), or a mobile device (e.g., 260-270). As illustrated in FIG. 6, the first off-site entity 604 includes or corresponds to a system administrator (e.g., 216), and the second off-site entity 606 includes or corresponds to a control center (e.g., 210) and/or a mobile device associated therewith (e.g., 260).

During operation, on-site system 602 monitors itself and analyzes sensor data to determine events and/or threats. The on-site system 602 may determine a status of the on-site system 602 and report the status to an off-site entity. As illustrated in FIG. 6, the on-site system 602 determines a status of components of thereof at 610, such as a status of sensors and countermeasures, and reports the status of such components to the first off-site entity 604 by sending a status message to the first off-site entity 604 at 612. In a particular implementation, the first off-site entity 604 sends an acknowledgement message to the first off-site entity 604 at 616 in response receiving to the status message at 614. The on-site system 602 receives the acknowledgment message at 618.

On-site system 602 receives sensor data from components thereof and compares the sensor data to database data to determine a match. For example, on-site system 602 receives image data from a local device of the on-site system 602 at a central computer of the on-site system 602 at 620, described further with reference to FIG. 8. The central computer identifies a potential threat at 622 and a location of the threat at 624 based on the image data and database data, as described with reference to FIG. 1. Sensor data may also include IR image data, audio data, or a combination thereof. In some implementations, the central computer identifies the potential threat and the location based on or based further on IR image data, audio data, or a combination thereof. To illustrate, the location of the threat may be determined by performing audio vector analysis.

Once a match (or potential match) is identified, the on-site system 602 may send the match out for verification or confirmation by a user. For example, the on-site system 602 may send a notification message or a match message to one or more of an on-site system admin or security person or an off-site entity, such as a mobile device thereof (e.g., 260-266). As illustrated in FIG. 6, the on-site system 602 sends a threat confirmation message to the first off-site entity 604 to solicit confirmation or verification of the threat at 626. Alternatively, the on-site system 602 may verify or confirm the match automatically. For example, if the match correlation value is above a threshold value or if either of a threat level or a combined threat level and match correlation value is above a threshold, the on-site system 602 verifies or confirms the match automatically.

As illustrated in FIG. 6, the first off-site entity 604 receives the threat confirmation message at 628 and generates a confirmation message based on user input. The first off-site entity 604 sends the confirmation message to the on-site system at 630. The on-site system 602 receives a confirmation message from the first off-site entity 604 indicating a confirmed or verified threat or a false positive at 632.

Once a match is made or a potential match is confirmed, the on-site system 602 may send a message to an off-site entity via a secure connection (e.g., existing or open secure connection) or may open a secure connection with the off-site entity. For example, a central computer of the on-site system 602 sends an alert message or a notification message to the first off-site entity 604 via a secure connection at 634, 636. As another example, a central computer of the on-site system 602 sends a message to second off-site entity 606 (e.g., a control center) including the identified threat and location via a secure connection.

Once the match or threat is confirmed, the on-site system 602 can take action, either by receiving or generating commands locally or receiving commands via a secure connection over a network or cellular network, as described further with reference to FIG. 7. As illustrated in the example of FIG. 6, exemplary actions may include generating alerts and/or notifications. The alert message may include preset information identifying a type of an event, a threat level of the event, or both. Alternatively, the alert message is configured to activate an alarm. The notification message may include information on the threat, a type of threat, a location of the threat, a response plan for the threat, a status of countermeasures and building security devices, etc., or a combination thereof. The notification or alert message can also be sent to mobile devices of one or more associates of the on-site system in addition to or in the alternative of sending such messages to off-site entities 504, 506.

Other exemplary actions include, sending an alert to mobile devices of one or more associates of the on-site system 602 responsive to identifying the threat and the location of the threat, activating an alarm responsive to identifying the threat and the location of the threat, or both. To illustrate, a silent alarm may be activated, an audible alarm may be activated, alarms in certain areas may be activated based on one or more of the location of the threat, event criteria, or a threat level, or a combination thereof.

In some implementations, an off-site entity has a secure connection with on-site system 602 and forwards communications and information received from on-site system 602 to other off-site entities and mobile devices. For example, as illustrated in FIG. 6 the second-off site entity 606 receives the threat message (i.e., a forwarded threat message) from the first off-site entity 604 at 638. The threat message may be forwarded in response to confirming the potential threat of the threat message. The second off-site entity 606 may optionally send confirmation message to the on-site system 602 at 640 in response to receiving the threat message at 638.

Optionally, the on-site system 602 may grant access to outside entities or devices that are pre-registered or authorized. For example, on-site system 602 may include a database of registered users, accounts, and/or devices and may enable security credentials of such users, accounts, and/or devices in response to a confirmed match or threat. As another example, the on-site system 602 may enable a registered or authorized mobile device or off-site entity to engage in a multi-factor authorization process to access on-site system 602/

Granting or providing access may include the on-site system 602 (e.g., by the central computer thereof) sending the image data, IR image data, audio data, or a combination thereof, to the control center via a secure connection. Additionally, granting or providing access may include routing or forwarding received command messages to countermeasure devices and generating control signals based on the received command messages, such as not blocking such message by a firewall. As an illustrative example, second off-site entity 606 may request access to on-site system 602 by sending an authorization request at 642. The authorization request may include multi-factor authentication data.

Referring to FIG. 7, an example operation of the system is shown. As illustrated in FIG. 7, example system 700 includes an on-site system 702, a first off-site entity 704, and optionally, a second off-site entity 706. On-site system 702 may include or correspond to on-site system 112, on-site system 212, system 300, system 400, system 502, or system 602. The first and second off-site entities 704, 706 may include or correspond to a control center (e.g., 210), a system administrator (e.g., 216), a network administrator (e.g., 218), or a mobile device (e.g., 260-270). As illustrated in FIG. 7, the first off-site entity 704 includes or corresponds to a system administrator (e.g., 216), and the second off-site entity 706 includes or corresponds to a control center (e.g., 210) and/or a mobile device associated therewith (e.g., 260). Alternatively, the first off-site entity 704 includes or corresponds to a control center (e.g., 210), and the second off-site entity 706 includes or corresponds to a mobile device associated therewith (e.g., 260). In such implementations, communications between the first off-site entity 704 and the second off-site entity 706 may be communicated over a cellular network (e.g., 220).

During operation, a threat identified by on-site system 702, such as described with reference to FIG. 6, may be identified, deterred, or incapacitated. After the identified threat is confirmed, on-site system 702 may enable countermeasures for use and grant outside devices, off-site entities and mobile devices, access to on-site system 702 at 710. For example, on-site system 702 may remove software or hardware based locks from countermeasures and/or may grant one or more users access. To illustrate, a firewall (e.g., 158) may allow particular communications and/or communication via particular ports. As another illustration, previously registered users may have their authorizations enabled or access granted.

Sensor data generated at on-site system 702 is sent to one or more off-site entities in response to identifying a threat, granting access, or a sensor data request, at 712. As illustrated in FIG. 7, a particular off-site entity (e.g., the first off-site entity 704) may forward the sensor data, at 714, to another off-site entity (e.g., the second off-site entity 706). In the example of

FIG. 7, the second off-site entity 706 receives the sensor data at 716. The second off-site entity 706 may generate or update a GUI (e.g., 126) based on the sensor data. In some implementations, the control center generates a GUI based on the image/video data and database data of the control center. The GUI may include multiple selectable video feeds corresponding to video of different cameras of the on-site system 702.

The second off-site entity 706 generates a command message based on user input, such as via an input device of input devices 130 of FIG. 1, at 718. The on-site system 702 receives the command message from the second off-site entity 706 at 722. Optionally, the on-site system 702 receives the command message from the second off-site entity 706 indirectly, and the first off-site entity 704 forwards the command message to the on-site system at 720. The command message may include a control command.

The on-site system 702 generates a control command and/or signal based on the command message at 724 and activates or adjust a component (e.g., sensor or countermeasure) of on-site system 702 based on the control command/signal. To illustrate, a central computer of on-site system 702 receives a command message from the second off-site entity 706 (e.g., a control center thereof) via a secure connection and routes the command message to a sentry device of the on-site system. The command message is configured to cause activation of a non-lethal countermeasure of the sentry, as described further with reference to FIG. 8.

The on-site system 702 may continue to send sensor data to off-site entities at 728. As illustrated in FIG. 7, the second off-site entity 706 receives the sensor data at 730 and sends a building command message to the on-site entity 702 at 732. The on-site system 702 generates a building control command/signal to activate or adjust a building device or a building security device.

In some implementations, the on-site system 702 activates one or more building security devices, such as locks, loudspeakers, public address systems, alarms, etc. For example, the on-site system 702 generates a building control command based on the identified threat, the location of the threat, or a combination thereof, and sends the control command or control signals to a building security device. As another example, the on-site system 702 receives a building control command from an off-site entity and routes or forwards the building control command to a building security device. To illustrate, a police officer using a mobile device associated with second off-site entity 706 may issue a door unlock command or a door lock command.

In some implementations, one or more off-site entities receive a notification message from on-site system 702. To illustrate, the second off-site entity 706 (e.g., a control center thereof) receives a notification message from an on-site computer of the on-site system 702 via a secure connection. The notification message may include updated location information of the threat, other responding units, civilians near the threat, etc., or a combination thereof. The notification message may also be automatically pushed to mobile devices that were granted access to on-site system 702 at 710. Additionally, or alternatively, the notification message may include instructions for avoiding the threat, such as an evacuation route or instruction, i.e., hide and lock doors. In other implementations, a mobile device associated with the second off-site entity 706 generates a command message based on user input and sends the command message to the on-site system 702 via a cellular network or via a local wireless network of on-site system 702.

In some implementations, an off-site entity sends multiple command messages or multiple control commands in a command message. For example, the second off-site entity 706 sends a second command message (or a second control command) to the on-site system 702 (e.g., the sentry device thereof) to cause activation of a second non-lethal countermeasure of a countermeasure pod of the sentry device.

In some implementations, one or more off-site entities may send instruction messages, such as text messages, to the on-site system, one or more mobile devices associated with the on-site system, or a combination thereof. The instruction message may include information on how to escape and/or deal with the threat and may be received at the on-site system 702 via a secure connection or at the mobile devices via the cellular network. Alternatively, the on-site system 702 may send instruction or update massages to one or more mobile devices associated with the on-site system responsive to receiving the instruction message from the off-site entity (e.g., the control center).

After the event or threat has been completed, the on-site system 702 may send out a notification or alert, de-authorize access, or a combination thereof. For example, the on-site system 702 may send notification messages over a secure connection indicating an event is over or a threat has been extinguished or neutralized. As another example, the on-site system 702 may make a public address (PA) announcement over a PA system or localized loudspeakers or may send text messages via a cellular network to mobile devices associated with on-site system 702. Additionally, the on-site system 702 may de-authorize one or more entities or mobile devices. For example, the on-site system 702 may adjust privileges, adjust network settings, adjust the firewall settings, prevent access to on-site system via the cellular network, the wireless network, secure connection, or virtual private network, or a combination thereof.

Referring to FIG. 8, an example operation of an on-site system in an activated state system is shown. As illustrated in FIG. 8, example on-site system 800 includes a central computer 802 (e.g., a central controller), a first device 804, and a second device 806. On-site system 800 may include or correspond to on-site system 112, on-site system 212, system 300, system 400, system 502, system 602, or system 702. The first and second devices 804, 806 may include or correspond to security devices. First device 804 and second device 806 may include or correspond to detection devices 144, countermeasures 146, first device 304, second device 306, or first device 404. To illustrate, the first device 804, the second device 806, or both, may include or correspond to a surveillance device (i.e., include at least one sensor, such as camera, microphone, IR camera, etc.), a sentry device (i.e., include at least one countermeasure), or a combination thereof. As illustrated in FIG. 8, the first and second devices 804, 806 both include sensors and countermeasures.

During operation, the first and second devices 804, 806 generate sensor data at 810. For example, cameras (e.g., 342) of the devices 804, 806 capture images and generate image data, IR cameras (e.g., 342) of the devices 804, 806 capture IR signatures and generate IR signature data, acoustic sensors (e.g., 448, 344) of the devices 804, 806 capture audio and generate audio data, or a combination thereof.

The sensor data generated by the first device and the second device 804, 806 is sent to the central computer 802. For example, the first device and the second device 804, 806 send image data of the images to the central computer 802 over a local network at 812. In a particular implementation, the first device and the second device 804, 806 send the sensor data (e.g., image data) over a hardwired local area network. In other implementations, the second device 806 sends the sensor data (e.g., image data) to the first device 804 and the first device 804 forwards the sensor data from the second device 806 to the central computer 802 at 816.

The central computer 802 is configured to identify events or threats based on analyzing the sensor data received at 814, as described herein. For example, the central computer 802 compares the sensor data to database data to identify a match at 818. Additionally, the central computer 802 may perform analysis on the sensor data to determine a location of the event or threat at 818. For example, when the sensor data includes image data, such as visible or IR image data, the central computer 802 may use triangulation between multiple image sensors to determine the location. As another example, when the sensor data includes audio data, the central computer 802 may use vector processing to determine the location. The event or threat may be confirmed or verified as described with reference to FIG. 7.

The central computer 802 is configured to send command messages to device of system 800, and optionally to generate such command messages. For example, the central computer 802 sends a command message to the first device 804 at 820. In some implementations, the command message is received at central computer 802 from an off-site entity (e.g., a control center) via a secure connection. In other implementation, the command message is received from a mobile device associated with the control center via a cellular network or via a local wireless network of the on-site system 800. Alternatively, the central computer 802 may generate the command message based on user input, such as by user input into a mobile device associated with on-site system 800 or terminal of on-site system 800. Such mobile device or terminal may be associated with an on-site security office or law enforcement personnel.

The first device 804 or the second device 806 receive the command message from the central computer 802 via the local network at 822 and generate a control signal based on the command message at 824. The control signal is sent to a particular component of the first device 804 or the second device 806 to control or activate the particular component at 826. For example, the command message may be configured to cause activation of a non-lethal countermeasure or adjustment of a sensor. To illustrate, a capsule may be launched or a camera may be adjusted based on the command message. Additional command messages may be received at first device 804, the second device 806, or both, to activate other countermeasures, adjust sensors, etc.

In some implementations where a countermeasure pod of a device is hidden from view or recessed, such as located within a housing, a wall or a ceiling, one or more command messages may control deploying and rescinding the countermeasure pod or the device. For example, the countermeasure pod may be deployed prior to activation of the non-lethal countermeasure and activation of the non-lethal countermeasure may later be rescinded. As another example, the countermeasure pod may be deployed or rescinded based on threat level, event/threat type, location of threat, etc., or a combination thereof.

In some implementations, the operation may continue and the devices of system 800 continue to send sensor data to central computer 802 at 828, which receives the sensor data at 830. In a particular implementation, such as where command messages are generated off-site and received at central computer 802, the central computer 802 forwards a portion of the sensor data (e.g., one or more video feeds) to off-site devices and/or entities at 832. Additionally, command message may be received or generated at central computer 802 at 834. The command message(s) may be sent to devices of system 800. As illustrated in FIG. 8, the central computer 802 sends a command message to the second device 806 via the first device 804. To illustrate, the first device 804 receives and forwards the command message at 836 and the second device 806 receives the command message at 838. The second device 806 may generate a control signal and adjust a component at 840 and at 842 as described with reference to 824, 826.

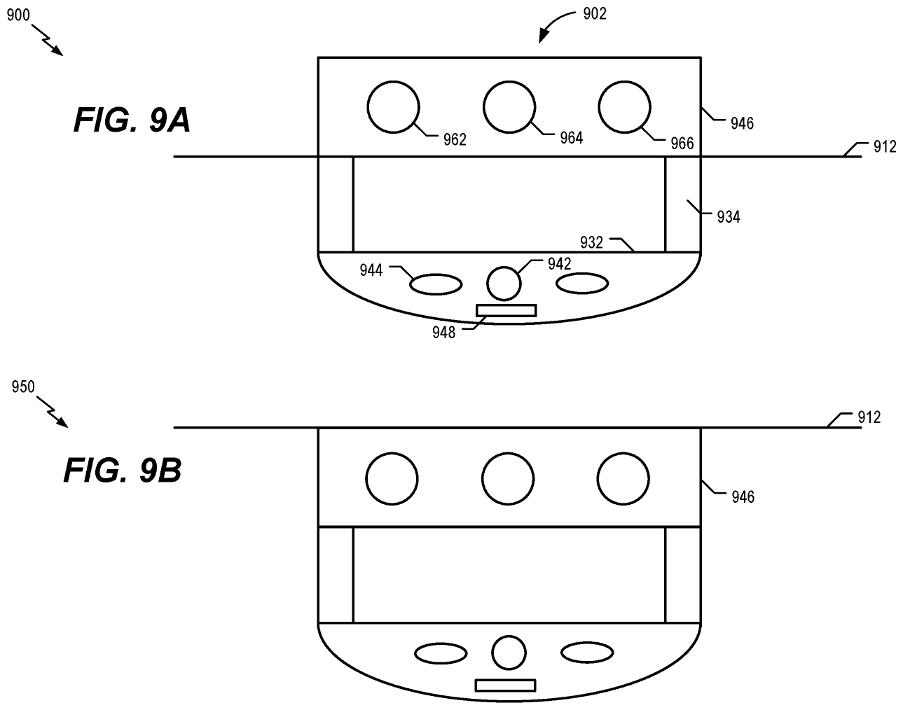

FIGS. 9A and 9B illustrate side views of an example of a device 902 of an on-site system in a retracted state and a deployed state. Referring to FIG. 9A, an example 900 of the device 902 in the retracted state is shown. The device 902 may include or correspond to first device 304, second device 306, or first device 404. As illustrated in FIG. 9A, device 902 is coupled to a ceiling 912 (or a wall) and includes mount 932, a motor 934, a camera 942, acoustic sensors 944, a non-lethal countermeasure pod 946, and an IR sensor 948. When in the retracted state, the non-lethal countermeasure pod 946 is recessed into the ceiling 912 and is hidden from view.

Referring to FIG. 9B, an example 950 of the device 902 in the deployed state is shown. As illustrated in FIG. 9B, the non-lethal countermeasure pod 946 protrudes from the ceiling 912 and is viewable when in the deployed state. Accordingly, countermeasures 962-966 of the non-lethal countermeasure pod 946 can be activated. During operation, a digital reticle can be used to provide aiming and guidance for one or more of the countermeasures 962-966. To illustrate, the video feed from the camera 942 includes a digital crosshair. As another example, when non-lethal countermeasure pod 946 includes a laser, the laser can be used to provide aiming and guidance for one or more of the countermeasures 962-966. The laser can be a distinct countermeasure that is used to deter threats and that is also used to aim another countermeasure, such as a capsule launcher.

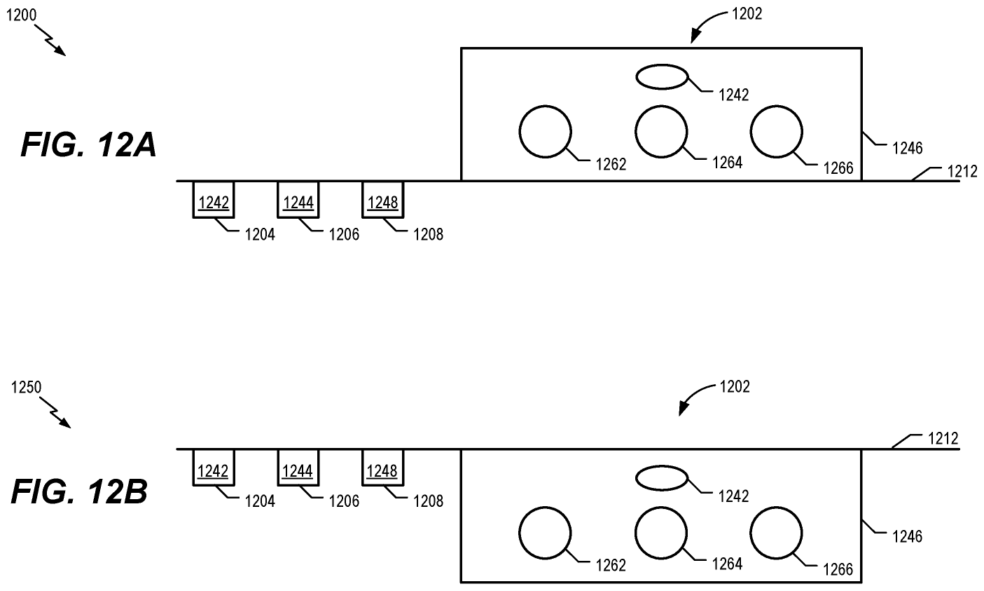

FIGS. 10, 11, 12A, and 12B, illustrate examples of distributed configurations for on-site systems, or more distributed configurations as compared to the configurations of on-site systems 300 and 400 of FIGS. 3 and 4. The exemplary distributed configurations of FIGS. 10, 11, 12A, and 12B distribute one or more components of a first device (e.g., 304, 404, 1202, etc.) to one or more devices of multiple discrete devices. Such distributed configurations enable reduced costs and increased security because multiple components of the on-site system would have to be accessed, disabled, or tampered with to incapacitate or reduced functionality of such a distributed on-site system. Additionally, such a distributed or modular system enables easier adoption and upgrades of components with reduced costs. To illustrate, existing cameras or speakers of a facility can be used and incorporated into the on-site system or a single component can be upgraded without replacing other components. As illustrated in FIGS. 12A and 12B, such distributed components/devices may be placed in proximity of one another to enable such components/devices to operate in conjunction with one another.

Referring to FIG. 10, a block diagram of an example of an on-site system 1000 is illustrated. On-site system 1000 includes an on-site computer 1002, a first device 1004, a second device 1006, a third device 1008, and a fourth device 1010. On-site system 1000 may include or correspond to an on-site security system, such as on-site system 112, on-site system 212, on-site system 300, or on-site system 400.

As illustrated in FIG. 10, the second device 1006 includes or corresponds to a camera, such as camera 342. The third device 1008 includes or corresponds to an acoustic sensor, such as acoustic sensor 344. The fourth device 1010 includes or corresponds to a speaker, such as a communication device (e.g., 274) of a communication system. As illustrative, non-limiting examples, the fourth device 1010 includes or corresponds to a speaker or a loudspeaker of PA system.

As compared to FIG. 3, the first device 1004 does not include the (optional) acoustic sensor 344. Rather, the second device 1006 (e.g., a camera, such as camera 344), the third device 1008 (e.g., the acoustic sensor 344), and the fourth device 1010 (e.g., the speaker 450) are discrete devices/components. In a particular implementation, the camera 342 is used to aim or guide non-lethal countermeasures of the non-lethal countermeasure pod 346, and the second device 308 (e.g., the second camera) is used for object detection and/or facial recognition.

Although each of the second device 1006 (e.g., a camera, such as camera 344), the third device 1008 (e.g., the acoustic sensor 344), and the fourth device 1010 (e.g., the speaker 450) are illustrated as discrete components/devices in FIG. 10, in other implementations, one or more of the second device 1006 (e.g., a camera, such as camera 344), the third device 1008 (e.g., the acoustic sensor 344), and the fourth device 1010 (e.g., the speaker 450) may be included with each other or with the first device 1004. Additionally, other devices or components may be used with devices 1004-1010, such as an IR sensor (e.g., 448).

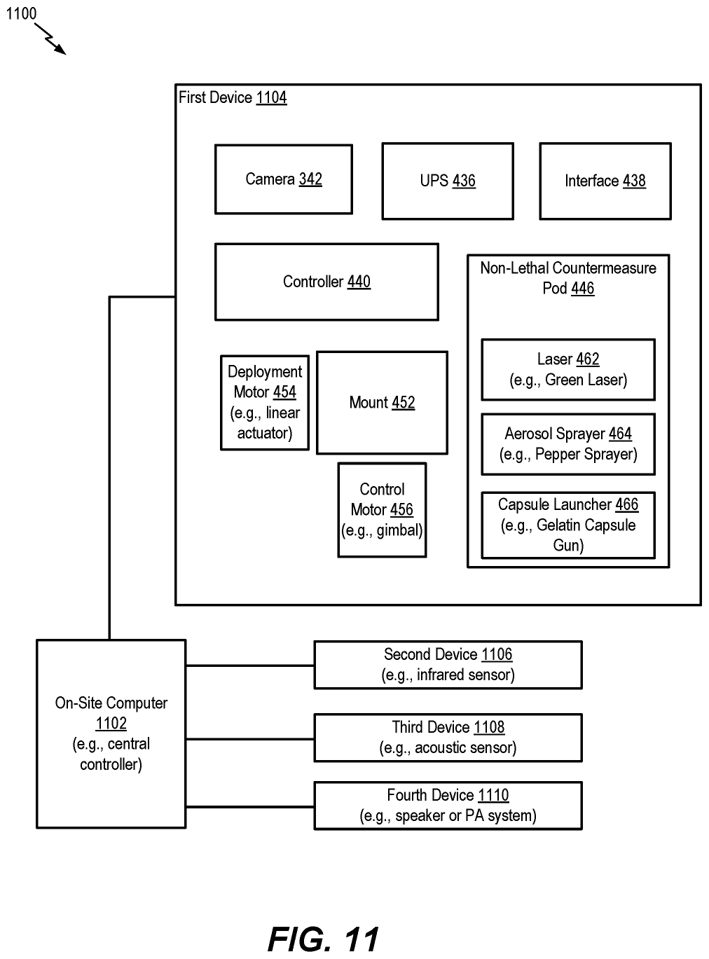

Referring to FIG. 11, a block diagram of another example of an on-site system 1100 is illustrated. On-site system 1100 includes an on-site computer 1102, a first device 1104, a second device 1106, a third device 1108, and a fourth device 1110. System 400 may include or correspond to an on-site security system, such as on-site system, 112, on-site system 212, on-site system 300, on-site system 400, or on-site system 1000. On-site computer 1102 may include or correspond to central computer 142 or on-site computer 302; first device 1104 may include or correspond to detection devices 144, countermeasure 146, first device 304, or a combination thereof.

In some implementations, the camera 342 is incorporated into the non-lethal countermeasure pod 446. In such implementations, the first device 1104 may include one mount and one motor (e.g., control motor 456). Optionally, the first device 1104 includes a deployment motor 454 configured to control deployment, retraction, or both. As compared to first device 404, first device 1104 may not include another mount and motor (432, 434) configured to move camera 342 independent of a corresponding mount or independent of the non-lethal countermeasure pod 446.

As illustrated in FIG. 11, the second device 1106 includes or corresponds to an infrared sensor, such as infrared sensor 448. The third device 1108 includes or corresponds to an acoustic sensor, such as acoustic sensor 344. The fourth device 1110 includes or corresponds to a speaker, such as a communication device (e.g., 274) of a communication system or speaker 450. As illustrative, non-limiting examples, the fourth device 1110 includes or corresponds to a speaker or a loudspeaker of PA system.

As compared to FIG. 4, the first device 1104 does not include the acoustic sensor 344, the infrared sensor 448, or the speaker 450. Rather, each of the acoustic sensor 344, the infrared sensor 448, and the speaker 450 are discrete devices/components. Although each of the acoustic sensor 344, the infrared sensor 448, and the speaker 450 are illustrated as discrete components/devices in FIG. 11 (i.e., devices 1106-1110), in other implementations, one or more of the acoustic sensor 344, the infrared sensor 448, and the speaker 450 may be included in or incorporated with each other or with the first device 1104.

FIGS. 12A and 12B illustrate side views of an example of devices 1202-1208 of an on-site system in a retracted state and a deployed state. Referring to FIG. 12A, an example 1200 of the device 1202 in the retracted state is shown. The device 1202 may include or correspond to first device 304, second device 306, first device 404, first device 1004, or first device 1104. As illustrated in FIG. 12A, device 1202 is coupled to a ceiling 1212 (or a wall) and includes a mount and motor (not shown), a camera 1242, and a non-lethal countermeasure pod 1246. When in the retracted state, the non-lethal countermeasure pod 1246 is recessed into the ceiling 1212 and is hidden from view. In the example illustrated in FIG. 12A, device 1204 includes a camera 1242 (e.g., a second camera), device 1206 includes one or more acoustic sensors 1244, and device 1208 include one or more IR sensors 1248. The sensors 1242, 1244, and 1248 may include or correspond to sensors 342, 344, and 448, respectively. Although only device 1202 is shown in a retracted state in FIG. 12A, in other implementations, one or more of devices 1204-1208 may be retractable.

In other implementations, one or more of devices 1202-1208 may be combined. Additionally, or alternatively, a component of one of devices 1202-1208 may be included in another device of devices 1202-1208.

Referring to FIG. 12B, an example 1250 of the device 1202 in the deployed state is shown. As illustrated in FIG. 12B, the non-lethal countermeasure pod 1246 protrudes from the ceiling 1212 and is viewable when in the deployed state. Accordingly, countermeasures 1262-1266 of the non-lethal countermeasure pod 1246 can be activated. During operation, a digital reticle can be used to provide aiming and guidance for one or more of the countermeasures 1262-1266. To illustrate, the video feed from the camera 1242 of device 1202 includes a digital crosshair. As another example, when the non-lethal countermeasure pod 1246 includes a laser, the laser can be used to provide aiming and guidance for one or more of the countermeasures 1262-1266. The laser can be a distinct countermeasure that is used to deter threats and that is also used to aim another countermeasure, such as a capsule launcher.

It is noted that one or more operations described with reference to one of the ladder diagrams of FIGS. 5-8 may be combined with one or more operations of another of FIGS. 5-8. For example, one or more operations of system 500 may be combined with one or more operations of system 800. Additionally, or alternatively, one or more operations described above with reference to FIGS. 1-4, 9A, 9B, 10, 11, 12A, 12B, 13, and 14 may be combined with one or more operations of FIG. 5, FIG. 6, FIG. 7, FIG. 8, or a combination of FIGS. 5-8.

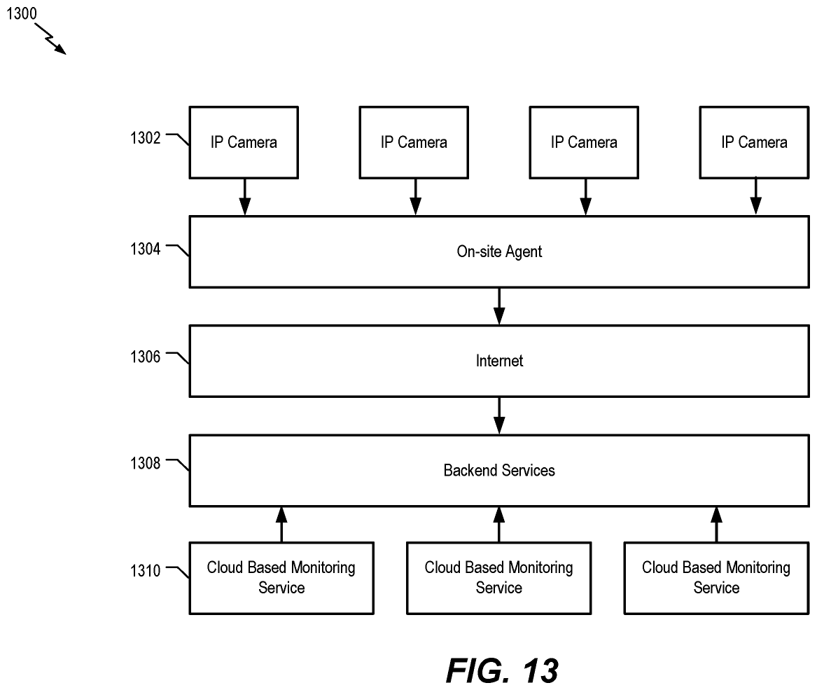

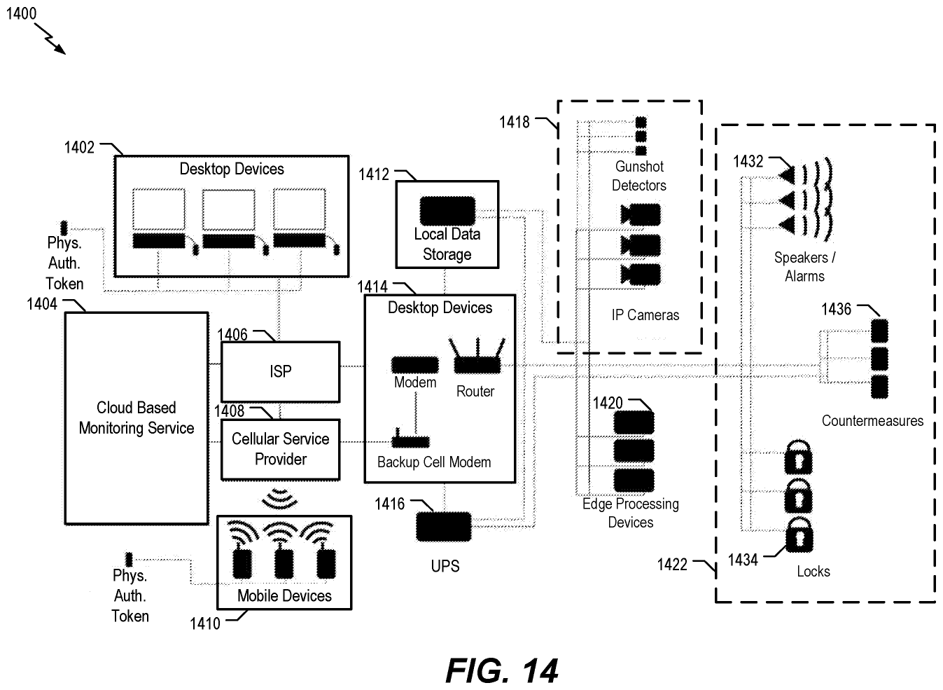

Referring to FIG. 13, a block diagram 1300 illustrating information flow in an example security system is illustrated. The security system (e.g., system 100, 200, or 1400 of FIG. 14) includes a plurality of internet protocol (IP) cameras 1302, an on-site agent 1304, internet infrastructure 1306, backend services 1308, and a plurality of mobile applications 1310. The plurality of internet protocol cameras 1302, the on-site agent 1304, the internet infrastructure 1306, the backend services 1308, and/or the plurality of mobile applications 1310 may include or correspond to one or more entities (e.g., 210, 212, 216, 218) of a security system described herein.

As illustrated in FIG. 13, the internet protocol cameras 1302 provide information to the on-site system agent 1304. For example, the internet protocol cameras 1302 relay video information and/or audio information received from a monitored area.

The on-site agent 1304 provides information to the backend services 1308 via the internet infrastructure 1306. For example, the on-site agent 1304 may review video, audio, and/or computer generated notifications and initiate transmission of confirmed notifications and/or alerts to a central server or remote monitoring station (such as the backend services 1308). Alternatively, the on-site agent 1304 may transcode video, audio and or computer generated notifications data and transmit it to a central server or remote station for processing. The backend services 1308 may also receive information from the plurality of mobile applications 1310. For example, the backend services 1308 may receive soft alerts or authentication requests and/or information from one or more mobile applications 1310, as described further with reference to FIG. 14.

Referring to FIG. 14, a block diagram of another illustrative security system 1400 (“referred to as system 1400”) is illustrated. System 1400 includes one or more desktop computers 1402, a cloud based monitoring service 1404, an ISP 1406, a cellular service provider 1408, a plurality of mobile devices 1410, local data storage 1412, communication infrastructure 1414 (e.g., a modem, a router, a backup modem and/or router (such as a cellular modem), etc.), a UPS 1416, monitoring devices 1418, edge processing devices 1420, and safety devices 1422. The monitoring devices 1418 may include audio gunshot detectors, image capture devices, or a combination thereof; the safety devices 1422 may include one or more public speakers 1432, alarms, door locks 1434, countermeasures 1436, etc. A cloud based monitoring service 1404 may include cloud based processing, such as graphics processing of video data in order to generate alerts. To illustrate, cloud based monitoring system 1404 may perform object detection and/or audio detection on received data.

Components 1412-1422 may include or correspond to an on-site security system, such as described with reference to the preceding figures. One or more components of the on-site security system may communicate with external components and systems via the ISP 1406 and/or the cellular service provider 1408. For example, the components of the on-site system may communicate with the desktop computers 1402 and/or the mobile devices 1410 directly or indirectly via the cloud based monitoring service 1404. The system 1400 may perform one or more actions described with reference to any of the preceding figures.

As illustrated in FIG. 14, components of system 1400 may be authenticated using an authentication token, such as a physical authentication token. For example, a physical authentication token may be coupled to an external device (e.g., 1402/1410) to register the device. As another example, two factor authentication and/or device authentication may be used in addition to or in the alternative of physical authentication tokens. To illustrate, data stored in secure portions of devices, such as a secure enclave, may be used for device registration/authentication and/or access. As an exemplary aspect, a new device (e.g., new user) may register with the system 1400, such as the cloud monitoring service 1404, by scanning a Quick Response (QR) code on a website or on a physical object. The device may receive a biometric input and biometric information from a user to secure the QR code or information retrieved based on scanning the QR code in a secure portion of the device. Accordingly, the specific combination of user and device may access a portion of the system 1400.

Once authenticated and access is granted, an external device (1402 or 1410) may perform one or more actions. For example, devices physically located on-site and belonging to users associated with the site may generate alerts and/or provide information. To illustrate, a student may generate a soft alert which is sent to the cloud based monitoring system 1404 or an on-site administrator for confirmation or indicate information about themselves during an alert (e.g., position and status information). As other illustrations, a first responder may respond to (e.g., accept) an individual dispatch or provide status and position information (e.g., dropping a pin on a map) while connected. Emergency Services (e.g., state and/or federal dispatch services, such as 911 dispatch services) may create an incident event and dispatch first responders, such as police, fire, or emergency medical services, to the incident location via the cloud based monitoring system 1404. For example, public service dispatch operators may enter the incident information on a map (e.g. drop a pin on a map) and submit the incident information to first responders as a dispatch notification. Emergency Services users may receive a notification of the incident permitting the users to perform a variety of actions such as acknowledge incident, accept incident, navigate to location, decline incident, etc.

Additionally, or alternatively, users of external devices (e.g., 1402 and 1410) may create an incident event and generate dispatch notifications or initiate generation of dispatch notifications by the cloud based monitoring system 1404. The dispatch notifications are sent (e.g., relayed) to other external devices (e.g., devices of first responders) by the cloud based monitoring system 1404.

Although the example system 1400 of FIG. 14 includes a cloud based monitoring system 1404 and has been described as operating based on cloud processing (e.g., data processing and/or alert management by the cloud based monitoring system 1404), in other implementations system 1400 may employ edge or local processing. For example, the edge processing devices 1420 may do one or more of the following actions: authenticate external devices, process data generated locally, and generate alerts based on the data, or manage responses to the alerts. In a particular aspect, the edge processing devices 1420 may receive and analyze video data, generate an alert, confirm the alert, and send alert data (e.g., alter metadata) to the cloud based monitoring system 1404. Accordingly, the edge processing devices 1420 include one or more CPUs and optionally include one or more GPUs. The cloud based monitoring system 1404 may provide information to external devices about the alert, such as generate dispatch calls and provide alert overlays, etc.

The above specification and examples provide a complete description of the structure and use of illustrative examples. Although certain aspects have been described above with a certain degree of particularity, or with reference to one or more individual examples, those skilled in the art could make numerous alterations to aspects of the present disclosure without departing from the scope of the present disclosure. As such, the various illustrative examples of the methods and systems are not intended to be limited to the particular forms disclosed. Rather, they include all modifications and alternatives falling within the scope of the claims, and implementations other than the ones shown may include some or all of the features of the depicted examples. For example, elements may be omitted or combined as a unitary structure, connections may be substituted, or both. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one example or may relate to several examples. Accordingly, no single implementation described herein should be construed as limiting and implementations of the disclosure may be suitably combined without departing from the teachings of the disclosure.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims. The claims are not intended to include, and should not be interpreted to include, means-plus- or step-plus-function limitations, unless such a limitation is explicitly recited in a given claim using the phrase(s) “means for” or “step for,” respectively.

1. A on-site security system comprising:
a central computer;
an object database including object data identifying a plurality of banned objects;
a network interface configured to communicate with a control center via a secure connection;
a plurality of devices coupled to the central computer, the plurality of devices including a first device and a second device; and
the first device comprising a camera, a communications interface, and one or more non-lethal countermeasures, wherein:
the central computer is configured to compare received image data to the object data of the object database to identify a banned object of the banned objects;
the central computer is configured to send a threat message to the control center;
the central computer is configured to receive a control command from the control center; and
the central computer is configured to activate at least one countermeasure of the one or more non-lethal countermeasures based on the control command.

2. The security system of claim 1, wherein the camera of the first device is configured to generate the image data, wherein the first device further comprises an infrared sensor, an acoustic sensor, or both, and wherein the central computer is configured to identify the banned object or a threat based further on IR signature data, audio data, or a combination thereof, received from the first device.

3. The security system of claim 1, the network interface comprising a router, a switch, and a firewall, and further comprising:
an uninterruptable power supply configured to supply power to one or more components of the on-site security system; and
a terminal coupled to the central computer and configured to receive alerts in response to identification of the banned object.

4. (canceled)

5. The security system of claim 1, further comprising user category data, event criteria, personnel data, and thresholds, wherein the central computer is configured to identify a threat based on one or more of the user category data, the event criteria, the personnel data, the thresholds, or a facial recognition database.

6. (canceled)

7. The security system of claim 1, wherein the central computer is coupled to one or more building security devices and is configured to activate one or more of the building security devices, and wherein the one or more building security devices include door locks, alarms, loudspeakers, a public address system, or a combination thereof.

8. The security system of claim 1, wherein the central computer is configured to receive access requests from the control center, and wherein the central computer is configured to adjust network settings of the network interface to authorize a mobile device to access a secure connection or a local wireless network of the on-site security system.

9. The security system of claim 1, wherein the central computer is configured to push updates to a mobile device based on an access level of the mobile device, and wherein the updates included location data, map data, threat data, route data, law enforcement data, or a combination thereof.

10. The security system of claim 1, wherein the central computer is configured to receive database updates from a control center, a system administrator, or both, and to update a detection database based on the database updates.

11. The security system of claim 1, wherein the central computer is configured to receive network updates from a network administrator and to update network settings, user category data, or both, based on the network updates.

12. The security system of claim 1, wherein the plurality of devices further comprises a second device, and wherein the second device comprises a second camera configured to capture images and to generate the image data, and wherein the first camera is configured to generate second image data associated with the one or more non-lethal countermeasures.

13. The security system of claim 1, wherein the plurality of devices further comprises a third device, wherein the third device comprises an IR sensor, an acoustic sensor, a speaker, or a combination thereof, and wherein the central computer is configured to identify the banned object or a threat based further on IR signature data, audio data, or a combination thereof.

14. A method comprising:
receiving, at a central computer of an on-site system, image data from a local device of the on-site system;
identifying, at the central computer, a threat and a location of the threat based on the image data and database data;
sending, by the central computer, a message to a control center including the identified threat and location via a secure connection;
receiving, at the central computer, a command message from the control center via the secure connection; and
routing the command message to a sentry device of the on-site system, the command message configured to cause activation of a non-lethal countermeasure of the sentry device.

15. The method of claim 14, further comprising identifying, at the central computer, the threat and the location of the threat based further on IR image data, audio data, or a combination thereof.

16. The method of claim 14, further comprising sending, by the central computer, the image data, IR sensor data, audio data, or a combination thereof, to the control center via the secure connection.

17. The method of claim 14, further comprising:
generating a notification responsive to identifying the threat and the location of the threat; and
sending the notification to mobile devices of one or more associates of the on-site system.

18. The method of claim 14, further comprising:
sending an alert to mobile devices of one or more associates of the on-site system responsive to identifying the threat and the location of the threat; or
activating an alarm responsive to identifying the threat and the location of the threat.

19. (canceled)

20. The method of claim 14, further comprising:
receiving, at the central computer, an instruction message from the control center via the secure connection; and
sending update messages to one or more mobile devices associated with the on-site system responsive to receiving the instruction message from the control center.

21. The method of claim 14, further comprising:
sending a threat neutralized message based on user input; and
de-authorizing the control center.

22-43. (canceled)

44. The on site security system of claim 1, wherein the secure connection includes a virtual private network, a HTTPS secure protocol extension, Secure Sockets Layer (SSL), Transport Layer Security (TLS), Secure Shell (SSH), Public Key Infrastructure (PKI), public-key cryptography, or end-to-end encryption (E2EE).

45. The security system of claim 1, wherein the first device further comprises an acoustic sensor, and wherein the acoustic sensor includes a piezoelectric effect device.
